(19) United States
(12) Patent Application Publication
(10) Pub. No.: US 2012/0197826 A1
(43) Pub. Date: Aug. 2, 2012

(54) INFORMATION MATCHING APPARATUS, METHOD OF MATCHING INFORMATION, AND COMPUTER READABLE STORAGE MEDIUM HAVING STORED INFORMATION MATCHING PROGRAM

(75) Inventor: Kazuo MINENO, Kawasaki (JP)

(73) Assignee: FUJITSU LIMITED, Kawasaki-shi (JP)

(21) Appl. No.: 13/307,050

(22) Filed: Nov. 30, 2011

(30) Foreign Application Priority Data
Jan. 28, 2011 (JP) 2011-017220

(51) Int. Cl. G06F 15/18

(52) U.S. Cl. 706/12

(57) ABSTRACT

The information matching apparatus includes: a training data rule setting unit that sets rules defining conditions for a training data of a positive example that is a pair of the records to be judged to be identical and a training data of a negative example that is a pair of the records to be judged to be non-identical; and a training data generating unit that, for the record of a matching source, generates a training data of the positive example by searching for the records of a matching target by using a positive example rule that is a rule defining conditions for the training data of the positive example, and generates a training data of the negative example by searching for the records of the matching target by using a negative example rule that is a rule defining conditions for the training data of the negative example.

### CROSS-REFERENCE TO RELATED APPLICATION

This application is based upon and claims the benefit of priority of the prior Japanese Patent Application No. 2011-017220, filed on Jan. 28, 2011, the entire contents of which are incorporated herein by reference.

### FIELD

The embodiment discussed here is directed to an information matching apparatus, a method of matching information, and an information matching program.

### BACKGROUND

Recently, in a variety of fields, supervised learning is used. The supervised learning represents a learning system in which labeled data is learned by a machine learning unit as supervised data, and the label of test data is predicted. As a machine learning unit of supervised learning, a support vector machine (SVM) is known.

For example, there is a technique using supervised learning for summarizing a text. In such a technique, by learning an existing text, a summary, and an evaluation (solution) as a case (supervised data), a relevance between the attribute that is a feature of the text and a summary result is acquired, and, by applying the acquired relevance to an unknown text, the summary of the text is derived (for example, see Japanese Laid-open Patent Publication No. 2004-253011).

In addition, there is a technique using supervised learning for identifying a content such as a moving image. In such a technique, a learning model is built by learning a feature amount (attribute) of a content of a positive example as an identification target and a feature amount (attribute) of a content of a negative example as a non-identification target in advance as supervised data, and it is determined whether or not an unknown content is a content of a positive example based on the built learning model (for example, see Japanese Laid-open Patent Publication No. 2006-099565).

In regards to records each configured by a set of values, as a function for matching the records and determining the identity, the similarity, and the relevance between the records, there is a name identification function. In the name identification function, for example, a pair (matching source) of records to be identified is referred to as a name identification source, and a pair (matching target) of records that are opponents for identification is referred to as a name identification target. FIG. 12 is a diagram illustrating the name identification function. As illustrated in FIG. 12, in a name identification process that realizes the name identification function, a record that is the same as the name identification source, a record that is similar to the name identification source, or a record that is relevant to the name identification source is detected from the name identification target, and a detection result is output as a result of the name identification process. In regards to the name identification function, there is a technique for name identification that uses supervised learning.

First, a conventional name identification function will be described with reference to FIGS. 13 to 15. FIG. 13 is a diagram illustrating the operation of the name identification function. As illustrated in FIG. 13, in a name identification process that realizes the name identification function, each record J1 of the name identification source is collated with records M (M1 to Mn) of the name identification target so that name identification is performed.

In the name identification process, the values of each item of the identification target (referred to as a “name identification item”) of the record J1 of the name identification source and a record M1 of the name identification target are collated by applying an evaluation function that is defined for each name identification item thereto. Here, it is assumed that the name identification items include a name, an address, and a date of birth, and, in the name identification process, a matching is made by applying each evaluation function of fa( ) to a name, fb( ) to an address, and fc( ) to a date of birth out of the name identification items. Then, the evaluation value of each name identification item that is derived as a result of the matching is weighted in accordance with the name identification item, and the acquired values are added together, whereby a total evaluation value is derived. In addition, in the name identification process, total evaluation values are derived for all the remaining records M2 to Mn of the name identification target with respect to the record J1 of the name identification source. In each name identification process, a name identification candidate set that includes the total evaluation values for pairs of the record J1 of the name identification source and the records M1 to Mn of the name identification target is generated.

Then, in the name identification process, a name identification is determined for pairs of records that belong to the name identification candidate set based on a threshold defined in advance. For example, in the name identification process, in a case where the total evaluation value is equal to a upper threshold, which is defined in advance, or more, it is determined that the records completely match, and the pair of the determined records is automatically determined as “White” so as to be output as the name identification result. On the other hand, in the name identification process, in a case where the total evaluation value is equal to a lower threshold, which is defined in advance, or less, it is determined that records never match, and the pair of the determined records is automatically determined as “Black” so as to be output as the name identification result. In addition, in a case where the total evaluation value is more than the lower threshold that is defined in advance and is less than the upper threshold, it is determined that it is difficult to automatically determine for the records, and a pair of the records which is difficult to automatically determine is output to a candidate list as “Gray”. Then, the determination of the pair outputted to the candidate list is assigned to a staff. In addition, as name identification definitions that need to be set by a staff, there are a selection of name identification items, a selection of evaluation functions, and setting of weighing factors and thresholds.

Next, a detailed example of the name identification process will be described with reference to FIGS. 14 and 15. FIG. 14 is a diagram illustrating an example of the data structure of name identification definitions, FIG. 14(A) illustrates the contents of the name identification definitions, and FIG. 14(B) illustrates a specific example of the name identification definitions. FIG. 15 is a diagram illustrating a detailed example of the name identification.

As illustrated in FIG. 14(A), in the name identification definition, a name identification method d1, a name identification source designation d2, a name identification target designation d3, a name identification item designation d4, and a threshold d5 are associated with one another for the definition. In the name identification method d1, a method of identifying names is designated. For example, as a method of identifying names, there is a “self name identification” in which name identification is performed between records within a set in a round-robin system with one record set being set as a target, and duplicate records are eliminated by detecting records that match each other. In the self name identification, since the name identification source and the name identification target are the same set, the structures (items of the record) thereof are the same. In addition, as another method of identifying names, there is a “different party name identification” in which name identification is performed on a combination of a name identification source record and a name identification target record, with respect to different pairs of the name identification source and the name identification target, records that match each other between the name identification source and the name identification target are detected, and the corresponding records are associated with each other. In the different party name identification, since the name identification source and the name identification target are different pairs, generally, the structures (items of records) thereof are different from each other. In the name identification source designation d2, access information of the name identification source such as a database name and items of a record of the name identification source are designated. In the name identification target designation d3, access information of the name identification target such as a database name and items of a record of the name identification target are designated. In the name identification item designation d4, the name identification items are designated as a combination of items of the name identification source and items of the name identification target, and an evaluation function and a weighting factor that are applied to each name identification item are designated. In addition, in the threshold d5, a upper threshold used for determining “White” and a lower threshold used for determining “Black” are designated.

As illustrated in FIG. 14(B), for example, in the name identification method d1, the “self name identification” is designated. In the access information of the name identification source designation d2, a “customer table” is designated, and, in the record information of the name identification source designation d2, items including an identification (ID), a name, a zip code, an address, and a date of birth are designated. In addition, in a case where the name identification method is the “self name identification”, the name identification target designation d3 is the same as the information of the name identification source, and a definition thereof is not necessary. In the name identification item designation d4, the name identification items are designated in the form of name: name, zip code: zip code, address: address, and date of birth: date of birth. The reason for this is that the name identification item is designated with a set of an item of the name identification source and an item of the name identification target, and in a case where the name identification method is the “self name identification”, the record configurations are the same, and thus, generally, the same item names are designated as the set. For each name identification item, an evaluation function and a weighting factor to be applied are designated. For example, in a case where the name identification item is “name: name”, “edit distance” is designated as the evaluation function, and 0.3 is designated as the weighting factor. On the other hand, in a case where the name identification item is “zip code: zip code”, “complete same” is designated as the evaluation function, and 0.2 is designated as the weighting factor. In the threshold d5, 0.72 is designated as the upper threshold, and 0.26 is designated as the lower threshold. Hereinafter, a name identification item in which the same item names are paired will be represented as one item name. For example, “name identification item name: name” is represented as “name identification item name”. Here, the “edit distance” is an evaluation function that represents a minimum number of times of editing at the time of transforming the value of the name identification target into the value of the name identification source for a matching of values of the name identification items of the name identification source and the name identification target, as a distance. For example, in a case where a transformation is not necessary, 1.0 is returned, and, in a case where all the transformations are necessary, 0 is returned. On the other hand, in a case where some of the transformations are sufficient, a value in the range of 0 to 1.0 is returned in accordance with the number of the transformations, which is a value that decreases as the number of transformations increases. Here, the “complete same” is an evaluation function that represents whether or not two values completely same each other in matching of the values of the name identification items of the name identification source and the name identification target. In a case where the two values completely match each other, 1.0 is returned, but otherwise 0 is returned. In addition, the evaluation function is not limited thereto, and there is an “N-gram” that evaluates the degree in which N characters adjacent to each other for the value of the name identification source are included in the value of the name identification target or the like.

FIG. 15 illustrates an intermediate transition and a result of a name identification process with respect to one record M1 of the name identification source and each name identification target, as a part of the name identification process defined in FIG. 14. In the customer table M of the name identification target, for example, two million records are stored. In the name identification process, each one of the records is used as a name identification target and collated with the record M1 of the name identification source. For example, in the name identification process, as an intermediate result of the matching, for each pair of the record M1 of the name identification source and records M1 to M6 of the name identification target, a result of applying the evaluation function, a weighting result, and a total evaluation value are output with being associated with one another. Then, in the name identification process, after the matching, for each pair of the record M1 of the name identification source and the records M1 to M6 of the name identification target, the determination on the name identification is made, and the determination results are output.

Next, the name identification function performed by a machine learning unit corresponding to a machine learning will be described with reference to FIG. 16. FIG. 16 is a diagram illustrating name identification that is performed by the machine learning unit. As illustrated in FIG. 16, in the name identification process that realizes the name identification function, a machine learning unit that realizes supervised learning is provided. The learning unit acquires a training data that is supervised data representing an example of a record pair that represents a positive determination result and learns determination criteria used in the name identification process using the acquired training data. These determination criteria are used as a threshold that is applied to the weighting of each name identification item and the determination of a name identification target record.

Then, in the name identification process, a record of the name identification source is collated with a record of the name identification target, a determination of the name identification is made using the determination criteria acquired through learning, and the determination result is output. At this time, in the name identification process, a pair that is difficult to automatically determine for the name identification is output to the candidate list so as to be given over to a determination by a staff. Then, for the pairs output to the candidate list, by appropriately feeding back a training data in accordance with the determination made by a staff, the name identification process realizes a high-accuracy determination through supervised learning.

However, in conventional supervised learning in the name identification, there is a problem in that it is difficult to generate a training data efficiently and practically. In other words, since a training data is generated by a staff, cost incurs for generation of the training data, and accordingly, it is difficult to efficiently generate the training data. In addition, in an operation using the name identification process, it is difficult to reflect a specialized rule (operation rule) for the operation on the training data, and it is difficult to generate a training data on a practical basis. Furthermore, the cost for the determination made by a staff for a Gray-determined part that is difficult to automatically determine is high, and there is also a problem in that, even in a case where there is a contradiction between training datas at the time of feeding back a determination made by a staff to the training data, such a contradiction is unknown.

### SUMMARY

According to an aspect of an embodiment of the invention, an information matching apparatus includes a processor and a memory. The processor executes setting rules defining conditions for supervised data of a positive example that is a pair of the records to be judged to be identical and supervised data of a negative example that is a pair of the records to be judged to be non-identical as the supervised data used for learning judgment criteria used for the judgment through supervised learning; and generating a training data, for the record of a matching source, by generating the supervised data of the positive example by searching for the records of a matching target by using a positive example rule that is set at the setting and is a rule defining conditions for the supervised data of the positive example, and by generating the supervised data of the negative example by searching for the records of the matching target by using a negative example rule that is set at the setting and is a rule defining conditions for the supervised data of the negative example.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram illustrating the configuration of an information matching apparatus according to an embodiment;

FIG. 2 is a flowchart illustrating the sequence of a training data generating process according to an embodiment;

FIG. 3 is a flowchart illustrating the sequence of a training data verifying process according to an embodiment;

FIG. 4 is a flowchart illustrating the sequence of a name identification result determining process according to an embodiment;

FIG. 5A is a flowchart illustrating an example of a maintenance sequence of a training data according to an embodiment;

FIG. 5B is a flowchart illustrating an example of the maintenance sequence of a training data by reflecting a Cannot Judge name identification result on the training data, according to an embodiment;

FIG. 6 is a diagram illustrating a name identification process using training datas that are generated by a training data generating unit;

FIG. 7 is a diagram illustrating the detection of a contradiction in a training data by using a training data verifying unit;

FIGS. 8A to 8C are diagram illustrating an experimental example for checking the effect of resolving a contradiction in training datas;

FIG. 9 is a diagram illustrating a specific example of a training data verifying process according to an embodiment;

FIG. 10 is a diagram illustrating a specific example of a training data generating process according to an embodiment;

FIG. 11 is a diagram illustrating a computer that executes an information matching program;

FIG. 12 is a diagram illustrating a name identification function;

FIG. 13 is a diagram illustrating the operation of the name identification function;

FIG. 14 is a diagram illustrating an example of the data structure of a name identification definition.

FIG. 15 is a diagram illustrating a specific example of the name identification;

FIG. 16 is a diagram illustrating a name identification process using a learning unit;

FIG. 17 is a diagram illustrating a matching through learning;

FIG. 18 is a diagram illustrating a learning process of an SVM;

FIG. 19 is a flowchart illustrating the processing sequence of the name identification process through learning;

FIG. 20 is a diagram illustrating a learning model (an example of an SVM); and

FIG. 21 is a diagram illustrating the effect of learning.

### DESCRIPTION OF EMBODIMENT

Preferred embodiments of the present invention will be explained with reference to accompanying drawings. In the following embodiment, a case will be described in which a support vector machine (SVM) is used as a learning unit that allows the information matching apparatus to perform supervised-learning, and before the description of the embodiment is presented, a name identification technique using the SVM will be described. However, the invention is not limited to the embodiment.

Name Identification Technique Using SVM

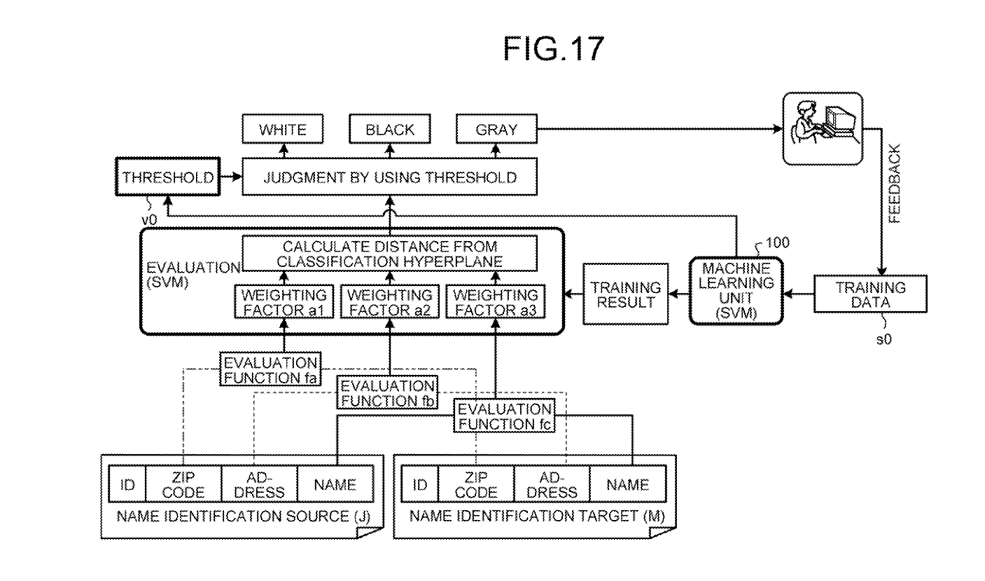

FIG. 17 is a diagram illustrating a matching through leaning. As illustrated in FIG. 17, a machine learning unit (SVM) 100 performs learning through a training data so by using results (evaluation values) of evaluation functions fa to fc for each name identification item as attributes and derives weighting factors a1 to a3 for each evaluation value as an attribute and a threshold v0 used for determining a total evaluation value by acquiring a classification hyperplane. The SVM 100 outputs the weighting factors a1 to a3 and the threshold v0 that have been derived as a learning result. Then, in a name identification process, a name identification is performed for a name identification source J by using a learning result of a name identification target M. In other words, in the name identification process, a matching is performed by using the weighting factors a1 to a3 that are output as learning results for each name identification item, and a total evaluation value, which is acquired as a matching result, as a determination target is calculated as a distance from the classification hyperplane derived through learning, and a determination is made for the total evaluation value based on the threshold. The classification hyperplane will be described later.

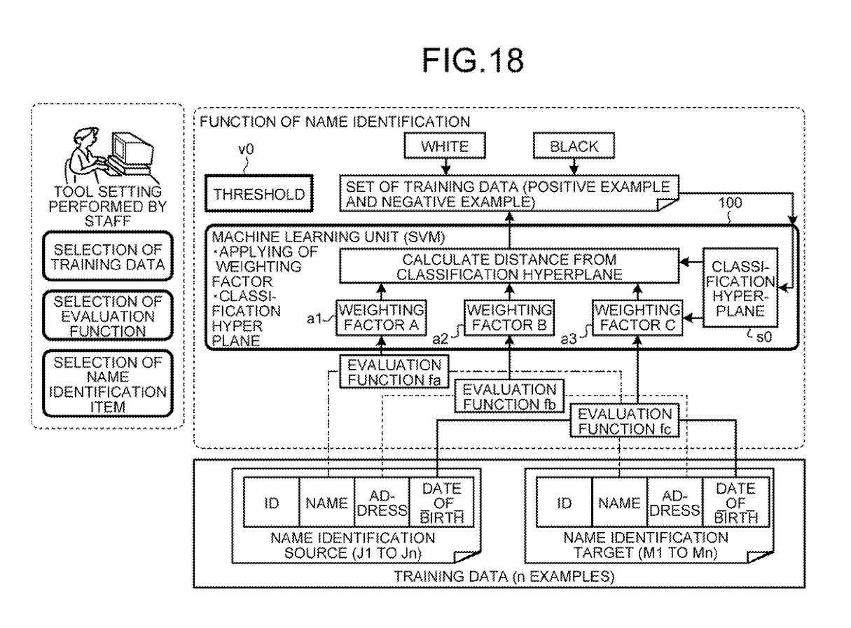

Next, the learning process of the SVM 100 will be described in more detail. FIG. 18 is a diagram illustrating the learning process of the SVM. As illustrated in FIG. 18, a set of training datas is input to the SVM 100, in which a pair of records to be determined to match each other is set to a training data of a positive example, and a pair of records to be determined not to match each other is set as a training data of a negative example. Then, the SVM 100 evaluates values of the name identification items of the name identification source J and the name identification target M based on the evaluation functions fa to fc using training datas belonging to the training data set that is input and derives determination criteria that realize a determination that matches a determination result (positive example=White, and negative example=Black) that is given in advance as the training data at the time of determining the results (evaluation values) acquired through the evaluation. The derived determination criteria are the weighting factors a1 to a3, the classification hyperplane s0, and the threshold v0 for each name identification item. Since the SVM 100 derives the weighting factors a1 to a3 and the threshold v0, the weighting factors and the threshold do not need to be set by a staff. As a result, according to the name identification function, a name identification can be performed by referring to the training datas. As name identification definitions that are needed to be set by a staff, there are selection of name identification items, selection of evaluation functions, and selection of a training data.

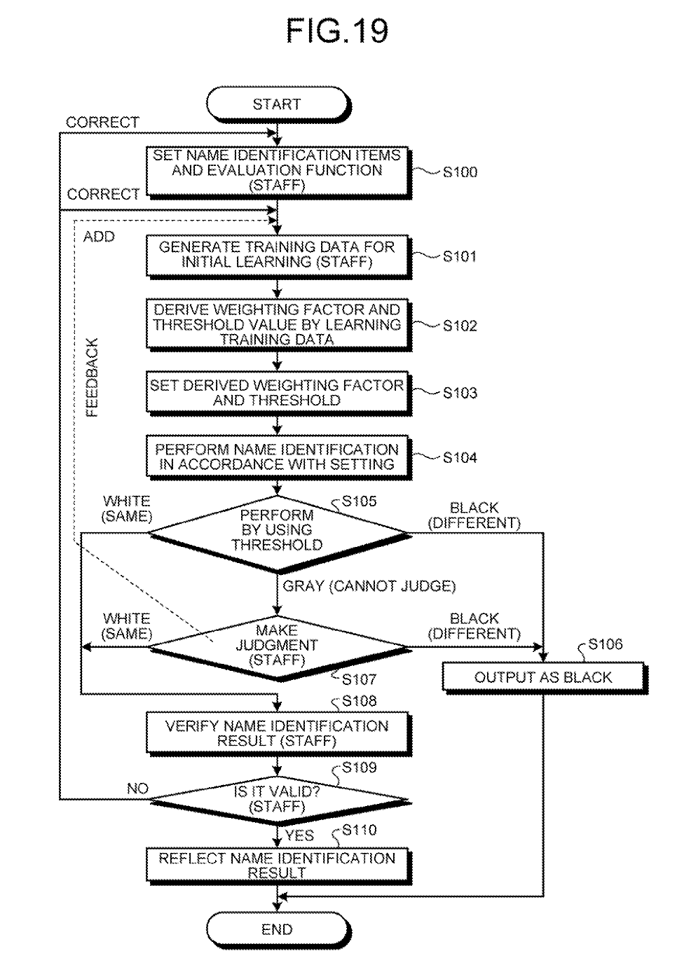

Next, the processing sequence of the name identification process through learning will be described with reference to FIG. 19. FIG. 19 is a flowchart illustrating the processing sequence of the name identification process through learning.

First, a staff (for example, a user) sets name identification items and evaluation functions for each name identification item in Step S100. Then, the user generates training datas for initial learning in Step S101. In other words, the user generates training datas as positive examples and training datas as negative examples.

Subsequently, the SVM 100 performs learning by using the generated training datas and derives the weighting factors and the threshold in Step S102. Then, the SVM 100 sets the weighting factors and the threshold that have been derived as a result of the learning in the name identification process in Step S103.

Subsequently, in Step S104 of the name identification process, a name identification is performed based on the weighting factors and the threshold that have been set. Then, in the name identification process, a judgment is made based on the set threshold for a total evaluation value that represents the result of the name identification in Step S105. In a case where the judgment made based on the threshold represents different (Black in Step S105), the result of the name identification is output as Black in Step S106. On the other hand, in a case where the judgment made based on the threshold represents same (White in Step S105), the name identification process proceeds to Step S108.

In a case where it cannot judge to make a judgment based on the threshold (Gray in Step S105), in the name identification process, the determination is left to the user in Step S107. In a case where the judgment made by the user represents different (Black in Step S107), the user allows the process to proceed to Step S106 for setting the result of the name identification to Black. On the other hand, in a case where the judgment made by the user represents same (White in Step S107), the name identification process proceeds to Step S108. Here, in a case where a feedback to the training data is done, for the feedback of the result of the name identification, the user allows the process to proceed to Step S101. At this time, a pair determined to be different (Black) is registered in the training data of a negative example, and a pair determined to be same (White) is registered in the training data of a positive example.

Subsequently, the user verifies the result of the name identification that has been judged to be same in Step S108. Then, the user judges whether or not the result of the name identification that has been judged to be same is valid in Step S109. In a case where the result of the name identification is determined not to be valid (No in Step S109), in order to modify the name identification items, the evaluation functions, or the training data, the process proceeds to Step S100 or Step S101. On the other hand, in a case where the result of the name identification is determined to be valid (Yes in Step S109), the result of the name identification is reflected on the name identification target and the like in Step S110. Here, in a case where the output of the pair determined to be Black is not necessary, Step S106 may be omitted.

Next, a learning model using an SVM as an example will be described. First, assumptions describing a learning model will be described. For a pair of records as name identification targets, the result of calculation using the evaluation function for each name identification item is represented as an attribute x so as to form a vector (x₁, . . . , x_{d}) referred to as a “feature vector”. For example, it is assumed that there are four name identification items including a name, a zip code, an address, and a date of birth, and the evaluation functions of the name, the zip code, the address, and the date of birth are fa( ) fb( ) fc( ) and fd( ) Then, in this example, d is “4”, and the feature vector is (an evaluation value acquired based on fa( ) an evaluation value acquired based on fb( ) an evaluation value acquired based on fc( ) and an evaluation value acquired based on fd( ).

Here, in a case where a feature vector X^{T} is (x₁, . . . , x_{d}), a classification hyperplane g(x) is defined as in Equation (1).

$$g ( x ) = {\sum }_{j = 1}^{d} {w}_{j} {x}_{j} + b = {W}^{T} \cdot X + b \qquad ( 1 )$$

Here, W denotes a weighting vector and is represented as (w₁, . . . , w_{d}) that is configured by weighting factors for each attribute. In addition, b denotes a constant term.

In addition, as learning sample data (training data), the following information is given.

(Z₁y₁), . . . (Zᵢyᵢ), . . . (Z₁y₁)ZᵢεRⁿyᵢε{+1,−1} (2)

Here, Zᵢ is a feature vector of each training data and is an element of a combined set Rⁿ of name identification matchings. In addition, yᵢ is a determination result of the name identification and, for example, is +1 in the case of a positive example and is −1 in the case of a negative example. In other words, in a case where the determination result of the name identification is regarded to be the same (White determination), +1 is defined as a positive example. On the other hand, in a case where the determination result of the name identification is regarded to be different (Black determination), −1 is defined as a negative example.

Under such assumptions, a learning process in a learning model represents acquiring a classification hyperplane that has a set of points satisfying g(x)=0 as a hyperplane when a plurality of training datas are given. In other words, in order to derive a classification hyperplane used for separating (identifying) training datas distributed in a d-dimension space such that a positive determination result or a negative determination result, which is designated in advance, is acquired for each training data, a weighting vector Wi (1≦i≦d) and a constant term b of the classification hyperplane g(x) are derived in the learning process. The classification hyperplane is a (d−1)-dimension hyperplane in a d-dimension space.

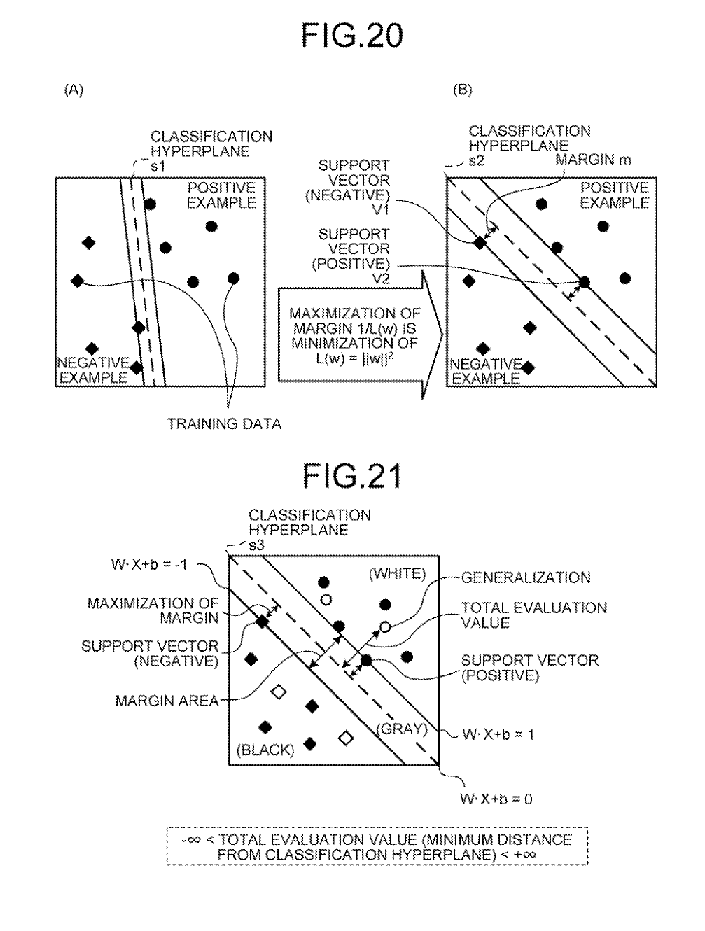

FIG. 20 is a diagram illustrating a learning model (an example of an SVM). As illustrated in FIG. 20(A), when a training data as a positive example and a training data as a negative example are given, the SVM performing a learning process plots the feature vector of each training data in a d-dimension space. Since FIG. 20 is a two-dimension diagram, a case is illustrated in which there are two name identification items. The SVM acquires a classification hyperplane s1, which is used for identifying each training data, for acquiring a result that coincides with the positivity or negativity of each training data. Here, an effective training data that is close to the classification hyperplane is referred to as a “support vector”. By selecting a support vector and deriving a hyperplane such that a minimum distance (margin) between the classification hyperplane and the support vector in an Euclid space is maximized, the SVM derives a classification hyperplane that can identify the positivity or negativity of each training data more reliably.

As illustrated in FIG. 20(B), the SVM selects a negative support vector V1 and a positive support vector V2 such that a margin m between the classification hyperplane and the support vector can be maximized and derives a classification hyperplane s2. Described in more detail, the maximizing of the margin m represents that a weighting factor W maximizing the feature vector X is acquired when the total evaluation value is 1 (=W^{T}·X+b). When b is assumed to be zero, X is 1/W. Accordingly, in order to maximize the feature vector X, the weighting factor W is minimized. Described in more detail, since the margin m of a case illustrated in FIG. 20(A) is larger than that of a case illustrated in FIG. 20(B), the SVM derives the classification hyperplane as illustrated in FIG. 20(B).

When the SVM derives a classification hyperplane so as to maximize the margin, there is a case where it is difficult to linearly classify a training data. In other words, there is a case where a training data does not coincide with its positivity or negativity. Even in such a case, the SVM allows an identification error to some degree and uses a method (called a soft margin) in which a classification hyperplane is derived so as to maximize the margin while minimizing the identification error.

As described above, through the learning process of the SVM, a classification hyperplane and a maximized margin can be acquired as the result of the learning process. By using this result of the learning process, the evaluation of a name identification can be performed for the feature vector of a pair of records as the name identification target. FIG. 21 is a diagram illustrating the effect of learning. As illustrated in FIG. 21, in the learning process, in order to maximize the margin, a classification hyperplane s3 on which W·X+b=0 is derived, and a negative limit plane on which W·X+b=−1 and a positive limit plane on which W·X+b=1 are selected. A total evaluation value that is calculated based on the feature vector X, the weighting factor W, and the constant b is represented as a value in the range of −∞ to +∞ as a minimum distance between the feature vector and the classification hyperplane s3. The total evaluation value of the support vector as supervised data that is in contact with the positive limit plane is +1, and the total evaluation value as supervised data that is in contact with the negative limit plane is −1. Accordingly, in the name identification process, when the total evaluation value of the feature vector of a pair of records as the name identification target other than the supervised data by using the weighting factor W and the constant b as the result of the learning is calculated (a mark ∘ or a mark ⋄ illustrated in FIG. 21), White, Black, or Gray can be determined based on the calculated total evaluation value. This feature is called generalization and is a distinctive feature of the SVM. In other words, White is determined in a case where the total evaluation value is +1 or more, Black is determined in a case where the total evaluation value is less than −1 (the direction of −∞), and Gray is determined in a case where the absolute value of the total evaluation value is less than one, whereby a determination can be realized which matches the training data.

In addition, the above-described total evaluation value is calculated based on the feature vector X, the weighting factor W, and the constant b, and although the principle of the SVM is described in which thresholds are fixed values as an upper limit threshold=W·X+b=+1 and a lower limit threshold=W·X+b=−1, by moving the constant term b to the right side, the thresholds can be variable values as an upper limit threshold=W·X=+1−b and a lower limit threshold=W·X=−1−b. In such a case, the total evaluation value can be calculated as W·X, and the thresholds can be calculated as the upper limit threshold=+1−b, and the lower limit threshold=−1−b.

In the embodiment illustrated below, an information matching apparatus, a method of matching information, and an information matching program that use a learning process of the SVM will be described.

Configuration of Information Matching Apparatus According to Embodiment

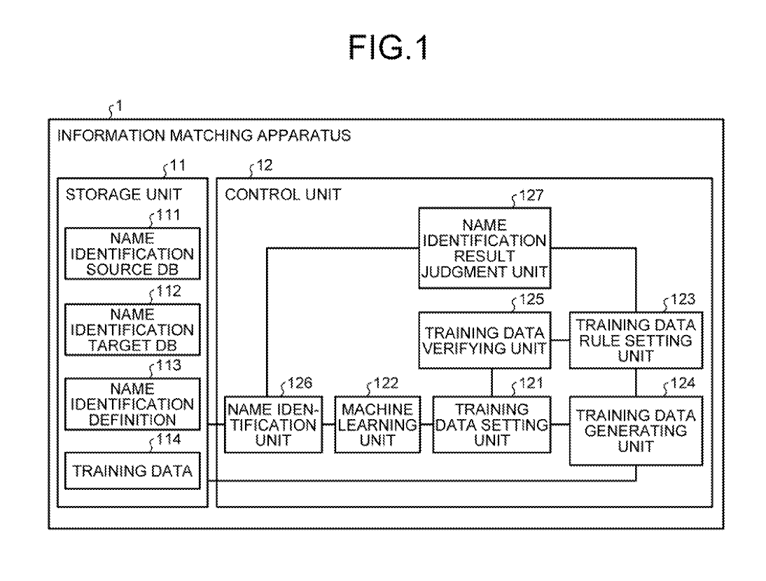

FIG. 1 is a functional block diagram illustrating the configuration of an information matching apparatus according to an embodiment. An information matching apparatus 1 is an apparatus that collates records for a plurality of records that are configured by a set of values corresponding to items and determines the identity, the similarity, and the relevance between the records. As illustrated in FIG. 1, the information matching apparatus 1 includes a storage unit 11 and a control unit 12.

The storage unit 11 includes a name identification source database (DB) 111, a name identification target DB 112, a name identification definition 113, and a training data 114. Here, the storage unit 11 is a storage device such as a semiconductor memory device, for example, a random access memory (RAM) or a flash memory, a hard disk, or an optical disc.

The name identification source DB 111 is a DB that stores a plurality of records (name identification source records) for which a name is identified. The name identification target DB 112 is a DB that stores a plurality of records (name identification target records) that are opponents of the name identification. Here, items of the name identification source DB 111 and items of the name identification target DB 112 may be completely matched, partially matched, or never matched, or some items thereof may have relevance. In addition, the name identification source DB 111 and the name identification target DB 112 may be DBs that have the same types of information or may be one DB. Furthermore, the name identification source DB 111 may not necessarily be a DB but may be an XML file, a CSV file, or the like as long as it has a sequential record fetching function. Similarly, the name identification target DB 112 may not necessarily be a DB but may be an XML file, a CSV file, or the like as long as it has a sequentially record fetching function and a search function using a key (ID).

In the name identification definition 113, a name identification method, a name identification source designation, a name identification target designation, a name identification item designation, and a threshold, which are used for a name identification, are defined in association with one another. In the name identification method, a method of identifying a name such as a self name identification or a different party name identification is designated. In the name identification source designation, access information of the name identification source DB 111 such as a database name and the items of the record of the name identification source DB 111 are designated. In the name identification target designation, access information of the name identification target DB 112 such as a database name and items of the record of the name identification target DB 112 are designated. In the name identification item designation, target items of the name identification are designated, and an evaluation functions and a weighting factor applied to each name identification item are designated. In the threshold, an upper threshold used for determining White and a lower threshold used for determining Black are designated. Here, the weighting factor and the threshold are default values, and the values actually used in the name identification process are a weighting factor and a threshold that are included in a learning result that is a result of the learning process of a machine learning unit 122 to be described later.

The training data 114 is supervised data as one set of a name identification source record and a name identification target record of which the result of the name identification is obvious, and there are a training data of a positive example that represents that the result of the name identification of both records is same and a training data of a negative example that represents that the result of the name identification of both records is different. Hereinafter, the supervised data is referred to as a “training data.

The control unit 12 generates training datas used for learning the determination criteria for the name identification by using the SVM based on rules that define conditions for training datas of the positive example and the negative example. Here, the rules that define the conditions for the training datas are referred to as “training data rules”. As the training data rules, there are a training data rule of a positive example (hereinafter, referred to as a “positive example rule”) and a training data rule of a negative example (hereinafter, referred to as a “negative example rule”).

In addition, the control unit 12 includes a training data setting unit 121, the machine learning unit 122, a training data rule setting unit 123, a training data generating unit 124, a training data verifying unit 125, a name identification unit 126, and a name identification result judgment unit 127. The control unit 12 is an integrated circuit such as an application specific integrated circuit (ASIC) or a field programmable gate array (FPGA) or an electronic circuit such as a central processing unit (CPU) or a micro processing unit (MPU).

The training data setting unit 121 sets a training data in a machine learning unit that learns determination criteria used for determining a result of the name identification. In this example, the machine learning unit corresponds to the machine learning unit 122 to be described alter and serves as an SVM. The training data setting unit 121 acquires training datas of positive and negative examples that are generated by the training data generating unit 124 and sets the training datas of the positive and negative examples in the machine learning unit 122. In addition, the training data setting unit 121 acquires a training data of a positive or negative example to be verified from the training data 114 of the storage unit 11 and sets the acquired training data in the training data verifying unit 125 to be described later.

The machine learning unit 122 acquires training datas of the positive and negative examples from the training data setting unit 121 and learns the determination criteria that are used in the name identification process by using the acquired training datas. These determination criteria become the weighting factor for each name identification item and the thresholds that are used for determining the name identification. In other words, the machine learning unit 122 performs learning through training datas by using the result (evaluation value) acquired based on the evaluation function for each name identification item as an attribute, derives a weighting factor for each attribute and a threshold as a classification hyperplane, and outputs the weighting factor and the threshold that have been derived to the name identification unit 126 as a result of the learning.

The training data rule setting unit 123 sets the training data rule that defines the conditions for training datas. A positive example rule of the training data rule defines the conditions for the training data of a positive example. On the other hand, a negative example rule of the training data rule defines the conditions for the training data of a positive example. Described in more detail, the training data rule setting unit 123 acquires a training data rule from an input device such as a keyboard connected to the information matching apparatus 1 and sets the training data rule in the training data generating unit 124, the training data verifying unit 125, and the name identification result judgment unit 127 to be described later. Alternatively, it may be configured such that a training data rule is stored in the storage unit 11 in advance, and the training data rule setting unit 123 acquires the training data rule from the storage unit 11 and sets the training data rule in the training data generating unit 124, the training data verifying unit 125, and the name identification result judgment unit 127 to be described later.

Here, a specific example of the training data rule in a case where the name identification items are the name, the address, and the date of birth will be described. For example, the positive example rule determines that a pair of records, of which names and addresses match, to be identical. More specifically, the positive example rule is described as below.

name identification source.name=name identification target.name AND name identification source.address=name identification target.address

Here, the name identification source.name represents the name item of the name identification source DB 111. The name identification target.name represents the name item of the name identification target DB 112. In addition, the name identification source.address represents the address item of the name identification source DB 111. In addition, the name identification target.address represents the address item of the name identification target DB 112.

In addition, it is assumed that a negative example rule determines a pair of records, of which the names match but the dates of birth do not match, to be different from each other. More specifically, the negative example rule is described as below.

name identification source.name=name identification target.name AND name identification source.date of birth name identification target.date of birth

Here, the name identification source.date of birth represents the date of birth item of the name identification source DB 111. In addition, the name identification target.date of birth represents the date of birth item of the name identification target DB 112. In addition, in a case where a plurality of training data rules is included, the training data rules are described (analyzed) as combined together with OR.

In addition, there are unspoken default rules in the training data rules. In other words, even in a case where a training data rule is not input through the input device such as a keyboard, the training data rule setting unit 123 sets unspoken training data rules, which are defined in advance, in the training data generating unit 124, the training data verifying unit 125, and the name identification result judgment unit 127. A positive example rule out of the unspoken training data rules is assumed to determine that a pair of records of which all the name identification items match is determined to be identical. In addition, a negative example rule out of the unspoken training data rules is assumed to determine that a pair of records, of which all the name identification items do not match, to be different. It is preferable that the training data rules including the unspoken training data rules are defined by reflecting job-related rules in accordance with a job using the name identification thereon.

The training data generating unit 124 generates a training data by searching the name identification target DB 112 with the training data rule set by the training data rule setting unit 123 used as conditions for the record of the name identification source. Such the training data generating unit 124 is effective in a case where the training data is automatically generated for the first time or in a case where all the training datas, which have already been generated, are automatically regenerated. Described in more details, the training data generating unit 124 searches the name identification target DB 112 with the positive example rule set by the training data rule setting unit 123 used as the conditions for the record of the name identification source, and thereby generating a training data of a positive example. In addition, the training data generating unit 124 searches the name identification target DB 112 with the negative example rule set by the training data rule setting unit 123 uses as the conditions for the record of the name identification source, and thereby generating a training data of a negative example.

In addition, the training data generating unit 124 may determine that a generated training data does not coincide with the conditions for other training data rules so as to resolve a contradiction between the training data and a training data rule. In other words, in a case where the generated training data is determined to coincide with any other training data rule, the training data generating unit 124 determines that there is a contradiction in the retrieved training data and removes the training data. Described in more detail, the training data generating unit 124 determines that a training data of a positive example that is generated with the conditions for a positive example rule does not coincide with the conditions for a negative example rule as the another training data rule. Then, in a case where the training data of the positive example is determined not to coincide with the conditions for any negative example rule, the training data generating unit 124 determines that there is no contradiction in the training data of the positive example. On the other hand, in a case where the training data of the positive example is determined to coincide with the conditions for any negative example rule, the training data generating unit 124 determines that there is a contradiction in the training data of the positive example and removes the training data of the positive example. In addition, the training data generating unit 124 determines that a training data of a negative example generated with conditions for a negative example rule does not coincide with the conditions for any positive example rule as another training data rule. Then, in a case where the training data of the negative example is determined not to coincide with the conditions for any positive example rule, the training data generating unit 124 determines that there is no contradiction in the training data of the negative example. On the other hand, in a case where the training data of the negative example is determined to coincide with the conditions for a positive example rule, the training data generating unit 124 determines that there is a contradiction in the training data of the negative example and removes the training data of the negative example.

The training data verifying unit 125 acquires a training data and determines that the acquired training data does not coincide with conditions for a training data rule of a classification opposite to the classification of the training data as a positive example or a negative example. In other words, in a case where the acquired training data is determined to coincide with the conditions for a training data rule of a classification opposite to the classification of the training data as a positive example or a negative example, the training data verifying unit 125 determines that there is a contradiction in the acquired training data. The training data verifying unit 125 is effective in a case where a user acquires a training data generated for the first time, acquires a training data that has already existed, or reflects a result of a determination made by a staff for a pair that cannot judge (Gray) on a training data and verifies the acquired training data.

Described in more detail, the training data verifying unit 125 acquires a training data from the training data setting unit 121 and, in a case where the acquired training data is a positive example, determines whether the acquired training data does not coincide with the conditions for a negative example rule. Then, in a case where the training data of the positive example is determined not to coincide with the conditions for a negative example rule, the training data verifying unit 125 determines that there is no contradiction in the training data of the positive example. On the other hand, in a case where the training data of the positive example is determined to coincide with the conditions for a negative example rule, the training data verifying unit 125 determines that there is a contradiction in the training data of the positive example and, for example, removes the training data of the positive example or warns the user about the contradiction. In addition, in a case where the acquired training data is a negative example, the training data verifying unit 125 determines whether the acquired training data does not coincide with the conditions for a positive example rule. Then, in a case where the training data of the negative example is determined not to coincide with the conditions for a positive example rule, the training data verifying unit 125 determines that there is no contradiction in the training data of the negative example. On the other hand, in a case where the training data of the negative example is determined to coincide with the conditions for a positive example rule, the training data verifying unit 125 determines that there is a contradiction in the training data of the negative example and, for example, removes the training data of the negative example or warns the user about the contradiction.

The name identification unit 126 performs a name identification using the learning result acquired through a learning process by the machine learning unit 122 and calculates a determination result of the name identification (hereinafter, referred to as a “name identification result”). Described in more detail, the name identification unit 126 acquires a learning result from the machine learning unit 122, performs a name identification by using the acquired learning result and the name identification definition 113, and calculates a name identification result. In the name identification result, a value that represents a White determination for which Same is presumed, a value that represents a Black determination for which Different is presumed, or a value that represents a Gray determination for which Cannot Judge is presumed is included.

The name identification result judgment unit 127 determines a classification of Same (White), Different (Black), or Cannot Judge (Gray) for a pair of records that is presumed to be undeterminable as a name identification result based on the name identification result. In other words, the name identification result judgment unit 127 makes a determination, which is based on the training data rule, for a pair of records for which the name identification result is determined to be Gray, whereby the number of sets of records that are needed to be determined by a staff can be decreased. Described in more detail, the name identification result judgment unit 127 acquires a pair of records for which the name identification result is determined to be Gray from the name identification unit 126 and determines whether the acquired pair of records coincides with the conditions for a positive example rule. Then, in a case where the acquired pair of records is determined to coincide with the conditions for a positive example rule, the name identification result judgment unit 127 determines whether the pair of records coincides with the conditions for a negative example rule. The reason for this is to determine a classification between Same (White) and Cannot Judge (Gray) for the pair of records that coincides with the conditions for the positive example rule. Then, in a case where the acquired pair of records is determined not to coincide with the conditions for the negative example rule, the name identification result judgment unit 127 determines the pair of records to be White for which the pair of records is presumed to be identical. On the other hand, in a case where the acquired pair of records is determined to coincide with the conditions for the negative example rule, the name identification result judgment unit 127 determines the pair of records to be Gray in which the pair of records is presumed to be undeterminable.

In addition, in a case where the acquired pair of records is determined not to coincide with the conditions for a positive example rule, the name identification result judgment unit 127 determines whether or not the pair of records coincides with the conditions for a negative example rule. The reason for this is to determine a classification between Different (Black) and No-determination (Gray) for the pair of records that does not coincide with the conditions for the positive example rule. Then, in a case where the acquired pair of records is determined to coincide with the conditions for the negative example rule, the name identification result judgment unit 127 determines the pair of records to be Black for which the pair of records is presumed to be not identical. On the other hand, in a case where the acquired pair of records is determined not to coincide with the conditions for the negative example rule, the name identification result judgment unit 127 determines the pair of records to be Gray in which the pair of records is presumed to be undeterminable.

Sequence of Training Data Generating Process According to Embodiment

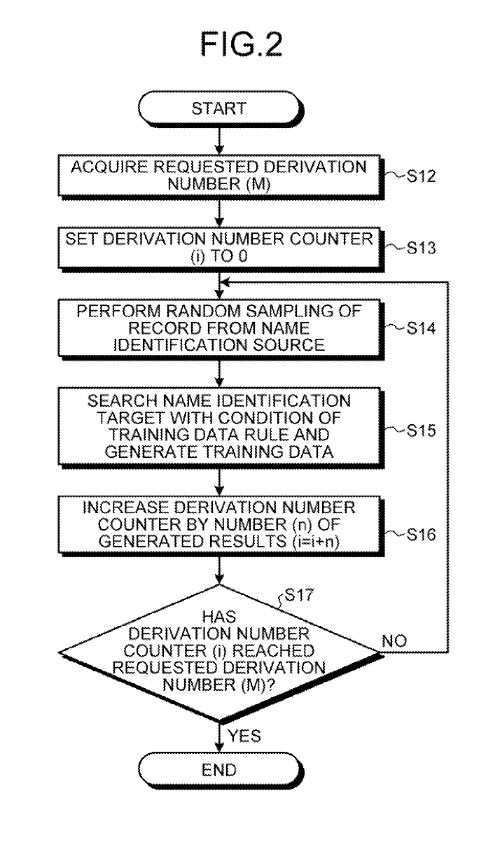

Next, the sequence of a training data generating process according to an embodiment will be described with reference to FIG. 2. FIG. 2 is a flowchart illustrating the sequence of the training data generating process according to an embodiment.

First, the training data generating unit 124 acquires a requested derivation number (M), for example, from the storage unit 11 in Step S12. Then, the training data generating unit 124 sets a derivation number counter (i) to “0” in Step S13.

Subsequently, the training data generating unit 124 randomly samples a record of a name identification source from the name identification source DB 111 in Step S14. Then, the training data generating unit 124 generates a training data by searching for a name identification target of the name identification target DB 112 by using the training data rule as the conditions for the sampled record of the name identification source in Step S15. Described in more detail, the training data generating unit 124 searches for a record of the name identification target of the name identification target DB 112 with the conditions of the positive example rule set by the training data rule setting unit 123 for the record of the name identification source and generates a training data of a positive example by forming a pair of the retrieved record of the name identification target and the record of the name identification source. In addition, the training data generating unit 124 searches for a record of the name identification target of the name identification target DB 112 with the conditions of the negative example rule set by the training data rule setting unit 123 for the record of the name identification source and generates a training data of a negative example by forming a pair of the retrieved record of the name identification target and the record of the name identification source. Here, in a case where a plurality of records is retrieved from the name identification target, one set of the training data is generated by selecting only one record that is a leading record or has a fewer Null values, whereby the training data can be dispersed further.

Then, the training data generating unit 124 increases the derivation number counter by the number (for example, n; here, n is a natural number) of results as generated training datas in Step S16.

Thereafter, the training data generating unit 124 determines whether or not the derivation number counter (i) has reached the requested derivation number (M) in Step S17. In a case where the derivation number counter is determined not to have reached the requested derivation number (No in Step S17), the training data generating unit 124 allows the process to proceed to Step S14 for sampling the next record of the name identification source. On the other hand, in a case where the derivation number counter is determined to have reached the requested derivation number (Yes in Step S17), the training data generating unit 124 ends the training data generating process.

In addition, it may be configured such that the training data generating unit 124, after Step S15, determines whether or not the generated training data coincides with other training data rules, and, in a case where the generated training data is determined to coincide with the conditions for another training data, removes the generated training data. In such a case, the training data generating unit 124 does not count up the derivation number counter for the removed training data in Step S16.

Sequence of Training Data Verifying Process According to Embodiment

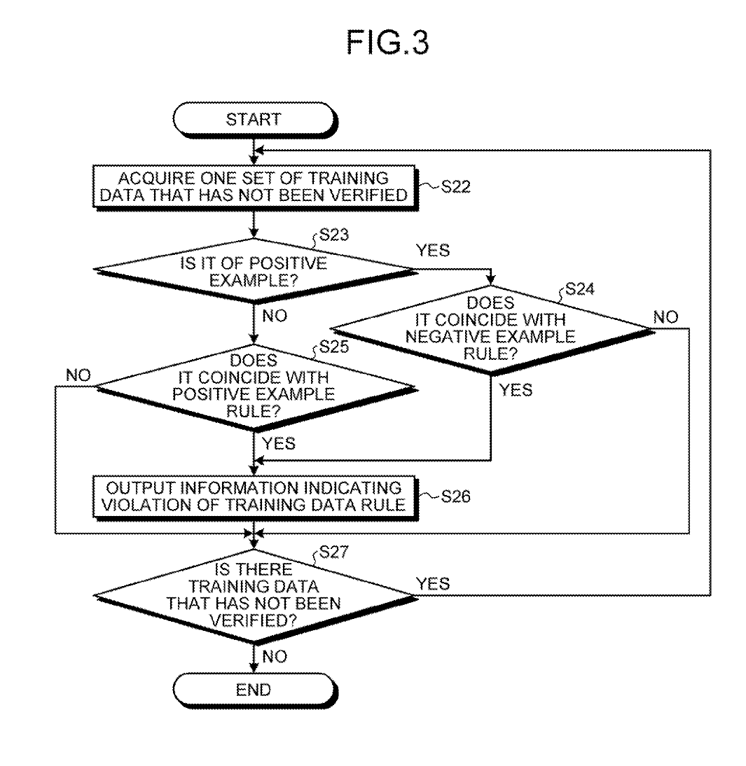

Next, a training data verifying process according to an embodiment will be described with reference to FIG. 3. FIG. 3 is a flowchart illustrating the sequence of the training data verifying process according to an embodiment.

First, the training data verifying unit 125 acquires one set of unverified training datas from the training data setting unit 121 in Step S22.

Then, the training data verifying unit 125 determines whether or not the acquired training data is a training data of the positive example in Step S23. In a case where the acquired training data is determined to be a training data of the positive example (Yes in Step S23), the training data verifying unit 125 determines whether or not the training data of the positive example coincides with the conditions for the negative example rule in Step S24. In a case where the training data of the positive example is determined not to coincide with the conditions for the negative example rule (No in Step S24), the training data verifying unit 125 determines that there is no contradiction in the training data of the positive example and allows the process to proceed to Step S27. On the other hand, in a case where the training data of the positive example is determined to coincide with the conditions for the negative example rule (Yes in Step S24), the training data verifying unit 125 determines that there is a contradiction in the training data of the positive example and outputs information representing that the training data violates the training data rule in Step S26. For example, the training data verifying unit 125 warns the user about the contradiction in the contradicted training data.

On the other hand, in a case where the acquired training data is determined not to be a training data of the positive example (No in Step S23), the training data verifying unit 125 determines the acquired training data to be a training data of the negative example and determines whether or not the training data of the negative example coincides with the conditions for the positive example rule in Step S25. In a case where the training data of the negative example is determined not to coincide with the conditions for the positive example rule (No in Step S25), the training data verifying unit 125 determines that there is no contradiction in the training data of the negative example and allows the process to proceed to Step S27. On the other hand, in a case where the training data of the negative example is determined to coincide with the conditions for the positive example rule (Yes in Step S25), the training data verifying unit 125 determines that there is a contradiction in the training data of the negative example and allows the process to proceed to Step S26.

The training data verifying unit 125 determines whether or not there is a training data that has not been verified in the training data setting unit 121 in Step S27. In a case where it is determined that there is a training data that has not been verified (Yes in Step S27), the training data verifying unit 125 allows the process to proceed to Step S22 so as to acquire the training data that has not been verified. On the other hand, in a case where it is determined that there is no training data that has not been verified (No in Step S27), the training data verifying unit 125 ends the training data verifying process.

In addition, in a case where it is desirable to perform strict checking, for a training data of the negative example, the training data verifying unit 125 may determine whether or not the training data of the negative example coincides with the rule of the negative example after “No” in Step S25. Then, in a case where the training data is determined not to coincide with the rule of the negative example, the training data verifying unit 125 allows the process to proceed to Step S26 for handling the violation of the training data, and, in a case where the training data is determined to coincide with the rule of the negative example, the process proceeds to Step S27. In addition, for a training data of the positive example, similarly to the case of the training data of the negative example, the training data verifying unit 125 may determine whether or not the training data coincides with a training data rule of a class that is the same as the class of the training data, that is, the negative example rule after “No” in Step S24.

Sequence of Name Identification Result Determining Process According To Embodiment

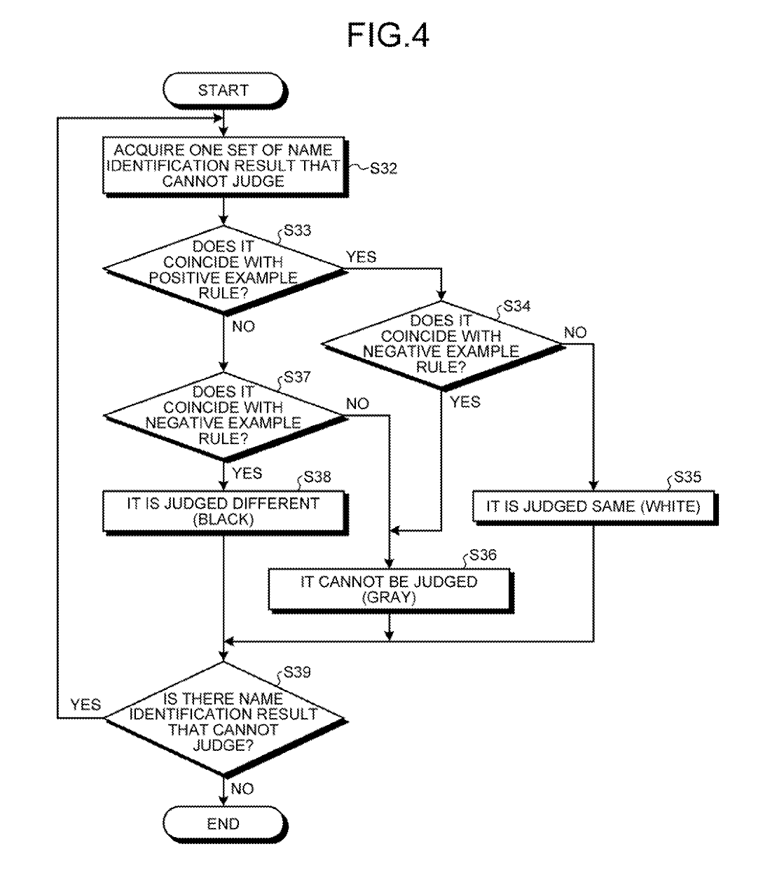

Next, the sequence of a name identification result determining process according to an embodiment will be described with reference to FIG. 4. FIG. 4 is a flowchart illustrating the sequence of the name identification result determining process according to an embodiment.

First, the name identification result judgment unit 127 acquires one set of name identification results that cannot judge from the name identification unit 126 in Step S32.

Then, the name identification result judgment unit 127 determines whether or not the acquired pair of records coincides with the positive example rule in Step S33. In a case where the acquired pair of records is determined to coincide with the positive example rule (Yes in Step S33), the name identification result judgment unit 127 determines whether or not the pair of records coincide with the negative example rule in Step S34. In a case where the pair of records is determined not to coincide with the negative example rule (No in Step S34), the name identification result judgment unit 127 judges the pair of records to be same (White) in Step S35. On the other hand, in a case where the pair of records is determined to coincide with the negative example rule (Yes in Step S34), the name identification result judgment unit 127 determines the pair of records that cannot judge (Gray) in Step S36.

On the other hand, in a case where the acquired pair of records is determined not to coincide with the positive example rule (No in Step S33), the name identification result judgment unit 127 determines whether or not the pair of records coincides with the negative example rule in Step S37. In a case where the pair of records is determined to coincide with the negative example rule (Yes in Step S37), the name identification result judgment unit 127 judges the pair of records to be different (Black) in Step S38. On the other hand, in a case where the pair of records is determined not to coincide with the negative example rule (No in Step S37), it cannot be judged (Gray) the pair of records in Step S36.

Thereafter, the name identification result judgment unit 127 determines whether or not there is a remaining name identification result, for which the result determining process is not performed, that cannot judge in Step S39. In a case where there is a remaining name identification result, for which the result determining process is not performed, presumed to be undeterminable (Yes in Step S39), the name identification result judgment unit 127 allows the process to proceed to Step S32 so as to acquire the next one set of name identification results presumed to be undeterminable. On the other hand, in a case where there is no remaining name identification result, for which the result determining process is not performed, presumed to be undeterminable (No in Step S39), the name identification result judgment unit 127 ends the name identification result determining process.

Maintenance Sequence of Training Data

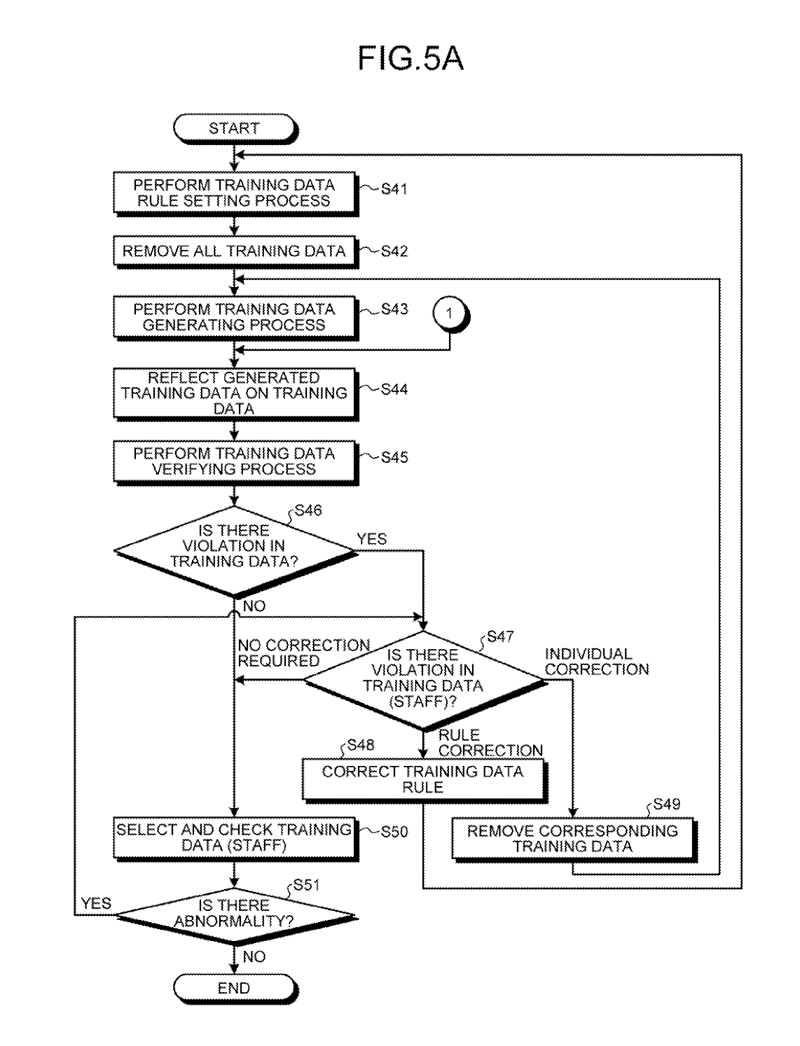

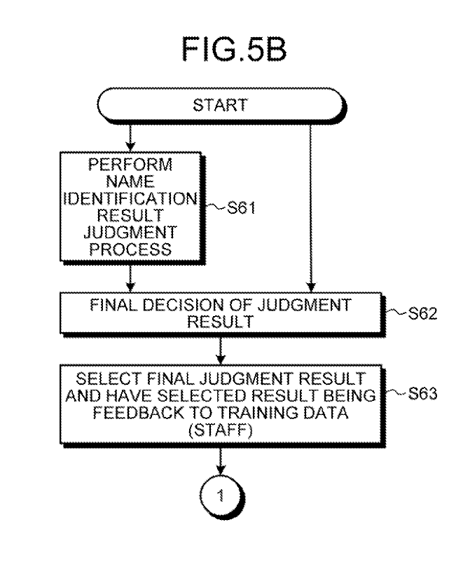

Next, the maintenance sequence of the training data will be described with reference to FIGS. 5A and 5B. FIG. 5A is a flowchart illustrating an example of a maintenance sequence of the training data according to an embodiment. FIG. 5B is a flowchart illustrating an example of the maintenance sequence of a training data by reflecting a Cannot Judge name identification result on the training data, according to an embodiment.

First, when the maintenance of training datas is started, the training data rule setting unit 123 performs a training data setting process in Step S41 and sets training data rules of the positive and negative examples in the training data generating unit 124, the training data verifying unit 125, and the name identification result judgment unit 127. Next, the control unit 12 removes all the training datas generated in the past in Step S42. This process of removing all the training datas in Step S42 is performed in a case where a training data is newly generated or newly regenerated and is an option that is omitted in a case where an existing training data is used. In addition, the training data generating unit 124 generates a training data with the training data rule set by the training data rule setting unit 123 used as the conditions by performing the training data generating process In Step S43.

Subsequently, the control unit 12 newly adds the generated training data or, in a case where there is an existing training data, overwrites the existing training data with the generated training data or adds the generated training data to the existing training data, thereby reflecting the generated training data on the training data in Step S44.

Subsequently, when the training data is acquired from the training data setting unit 121, the training data verifying unit 125 performs a training data verifying process so as to verify the acquired training data in Step S45 and determines whether there is a violation in the training data in Step S46. Then, in a case where a violation is determined in the training data by the training data verifying unit 125 (Yes in Step S46), it is determined whether or not there is a violation in the training data by a staff in Step S47.

Then, in a case where no violation is determined in the training data (no correction in Step S47), the process proceeds to Step S50 so as to leave final checking thereof to a staff as a training data candidate. On the other hand, in a case where it is determined that there is a violation in the training data and a case where correction of the training data rule is done (rule correction in Step S47), the training data rule is corrected by a staff in Step S48, and the process proceeds to Step S41. In addition, in a case where it is determined that there is a violation in the training data and a case where individual correction of the training data may be determined to be necessary (individual correction in Step S47), the training data is removed by a staff in Step S49, and the process proceeds to Step S43.

In a case where it is determined that there is no violation in the training data by the training data verifying unit 125 (No in Step S46), the training data is presented to a staff as a training data candidate, and final selection and checking are performed by the staff in Step S50. Then, it is determined whether or not there is abnormality in the training data by a staff in Step S51, and, in a case where it is determined that there is abnormality (Yes in Step S51), the process proceeds to Step S47 so as to allow a staff to determine the reason. On the other hand, in a case where it is determined that there is no abnormality (No in Step S51), the maintenance of the training data ends.

Next, in a case where the name identification result is determined to be not able to judged by the name identification unit 126, the name identification result judgment unit 127 acquires a pair of records that has been determined to be undeterminable from the name identification unit 126 and performs a name identification result judgment process for the acquired pair of records in Step S61. Here, by applying the training data rule set by the training data rule setting unit 123 to the acquired pair of records, the name identification result judgment unit 127 determines a classification of Same (White), Different (Black), and Cannot Judge. Then, for the pair of records determined to be the classification of Cannot Judge, a final decision of judgment result that represents a classification of Same (White) or Different (Black) is made by a staff in Step S62. Then, the final judgment result made by the staff is selected, and in order to reflect the pair of records representing the selected final judgment result on the training data, the feedback of the selected final judgment result to the training data is performed in Step S63. Thereafter, when the selected final determination result is reflected on the training data in Step S44, the maintenance of the training data on which the determination result is continuously reflected is performed.

Name Identification Using Training Data Generated by Training Data Generating Unit

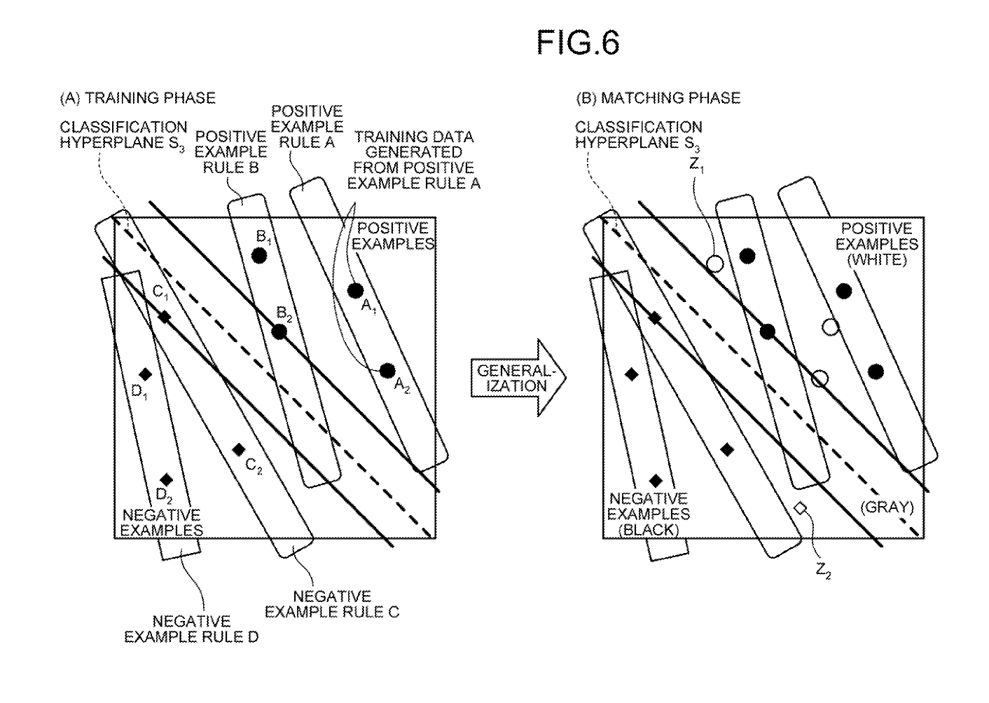

Next, a name identification using training datas generated by the training data generating unit 124 will be described with reference to FIG. 6. FIG. 6 is a diagram illustrating a name identification process using the training datas that are generated by the training data generating unit. FIG. 6(A) illustrates a learning result using the training datas generated by the training data generating unit, and FIG. 6 (B) illustrates a matching result using the learning result. As illustrated in FIG. 6(A), a positive example rule A and a positive example rule B are set in the training data rule of a positive example, and a negative example rule C and a negative example rule D are set in the training data rule of a negative example. The training data rules are set in the training data generating unit 124 by the training data rule setting unit 123. The training data generating unit 124 generates a training data from the set training data rules. Here, training datas A₁ and A₂ are generated from the positive example rule A, training datas B₁ and B₂ are generated from the positive example rule B, training datas C₁ and C₂ are generated from the negative example rule C, and training datas D₁ and D₂ are generated from the negative example rule D. The machine learning unit 122 performs learning by using the training datas of the positive example and the training datas of the negative example and derives a learning result that is based on the classification hyperplane S₃ that can be used for determining the positive and negative examples of the training datas more appropriately.

As illustrated in FIG. 6(B), the name identification unit 126 collates a pair of a record of a name identification source and a record of a name identification target by using the learning result derived by the machine learning unit 122. As a result, even in a case where a pair Z₁ of one record does not correspond to any of the positive example rules A and B and is in a gap between the positive example rules, the pair is determined to be White corresponding to a positive example based on the learning that is based on the generated training datas and the generalization. In addition, even in a case where a pair Z₂ of one record does not correspond to any of the negative example rules C and D and is in a gap between the negative example rules, the pair is determined to be Black corresponding to a negative example base on the learning that is based on the generated training datas and the generalization.

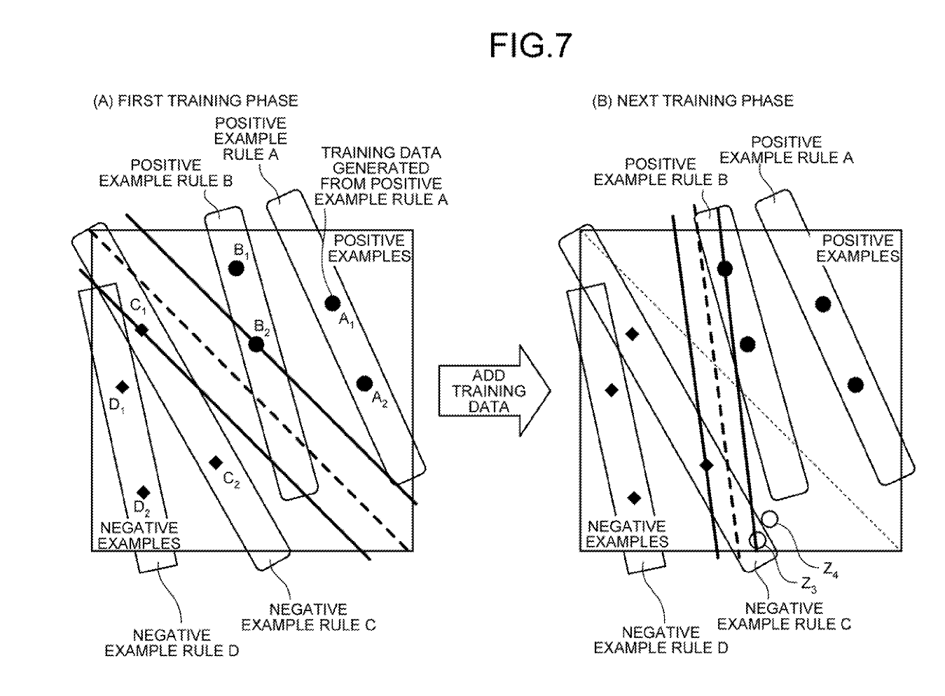

Next, the detection of a contradiction in the superimposed example by using the training data verifying unit 125 will be described with reference to FIG. 7. FIG. 7 is a diagram illustrating the detection of a contradiction in the training data by using the training data verifying unit. FIG. 7(A) illustrates a learning result using training datas generated by the training data generating unit, and FIG. 7(B) illustrates a learning result using training datas in a case where training datas are further added. Since FIG. 7(A) is similar to FIG. 6(A), the description thereof will not repeated here. As illustrated in FIG. 7(B), it is assumed that training datas Z₃ and Z₄ of the positive example are added. In such a case, in the learning result, the support vector changes due to the influence of the training datas of the positive example that are newly added, the classification hyperplane changes, whereby the margin decreases. The training data verifying unit 125 determines whether or not the training datas of the positive example do not coincide with the conditions for a negative example rule. Here, since the training data Z₃ of the positive example coincides with the conditions for the negative example rule C, the training data verifying unit 125 detects that there is a contradiction in the superimposed example Z₃ of the positive example. In addition, since the training data Z₄ of the positive example does not coincide with the conditions for the negative example rules C and D, the training data verifying unit 125 determines that there is no contradiction in the training data Z₄ of the positive example.

In a case where it is desirable to perform strict checking, the training data verifying unit 125 determines whether or not a training data of the positive example (for which no contradiction has been determined) that does not coincide with a negative example rule coincides with the conditions for a positive example rule. Here, since the training data Z₄ of the positive example does not coincide with the conditions for any of the positive example rules A and B, the training data verifying unit 125 detects that there is a contradiction in the training data Z₄ of the positive example.

Experimental Example for Checking Effect of Resolving Contradiction in Training Data

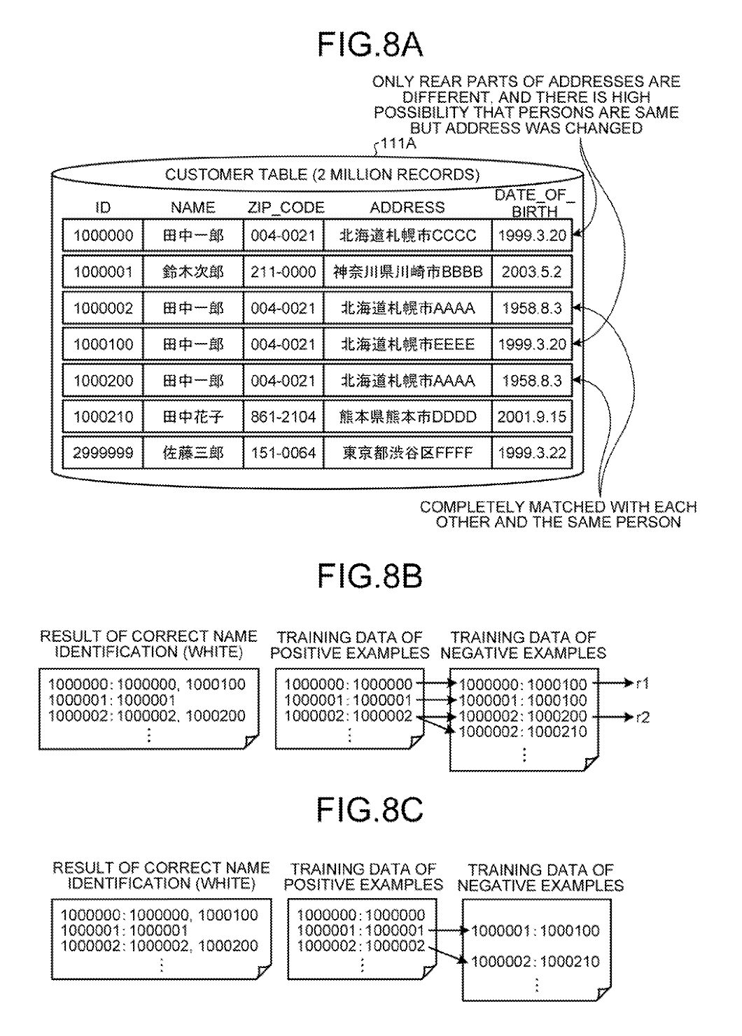

Here, an experimental example for checking the effect of resolving a contradiction in training datas will be described with reference to FIGS. 8A to 8C. FIGS. 8A to 8C are diagrams illustrating an experimental example for checking the effect of resolving a contradiction in training datas. FIG. 8A illustrates data of a name identification target. A database used in the experiment is a database of a customer table 111A that includes two million records. In the experiment, a name identification source and a name identification target are set as the same target data, and a self name identification using learning is performed so as to remove duplication of target data. Here, it is assumed that the name identification items are a name, an address, and a date of birth.

First, for training datas generated in advance, learning and a name identification are performed by using training datas having contradictions as illustrated in FIG. 8B. In the example illustrated in FIG. 8B, in a pair r1 of records of which IDs are “1000000” and “1000100”, the names and dates of births match, but only the rear parts of the addresses are different from each other, and thus there is a high possibility that the persons are the same, and the address has been changed. Thus the pair r1 of records is a training data having a contradiction in which an example to be originally set as a positive example is registered as a negative example. In addition, in a pair r2 of records of which IDs are “1000002” and “1000200”, the persons are the same having all the name identification items to match, and thus, the pair r2 of records is a training data having a contradiction in which an example originally to be originally set as a positive example is registered as a negative example.

Next, training datas having contradictions are detected out of training datas generated in advance by the training data verifying unit 125, and the contradictions in the detected training datas are resolved. As a result, as illustrated in FIG. 8C, the training datas of the negative example having contradictions illustrated in the examples illustrated in FIG. 8B are removed. Then, the learning and the name identification are performed for training datas having no contradiction.

In the experiment, for easy comparison, the total evaluation values as the name identification results are converted into total evaluation points through normalization. The total evaluation points are represented as 0 to 100 points and are normalized such that the classification hyperplane on which the total evaluation value is “0” is set to 50 points, an upper support vector plane on which the total evaluation value is “+1” is set to 72 points, and a lower support vector plane on which the total evaluation value is “−1” is set to 28 points. In the result of the experiment for two cases including a training data having a contradiction and a training data having no contradiction, there is the following tendency.

As a first tendency, a maximum value of the total evaluation point of the training data having no contradiction is relatively high. In other words, a maximum value of the total evaluation point is 73.09 in the training data having a contradiction, and a maximum value of the total evaluation point is 94.29 in the training data having no contradiction. Thus, the maximum value of the total evaluation point in the training data having no contradiction is higher than that in the training data having a contradiction by +21.20 points. In addition, as a second tendency, the accuracy of the name identification result is improved. In other words, the accuracy rate of the White judgment that judges Same in a case where a training data having no contradiction is higher than that in a case where a training data having a contradiction by 10%, and the number of Gray judgment as Cannot Judge in a case where the training data having no contradiction is less than that in a case where the training data having a contradiction by 6%. As a result, the determination resolution in the name identification process increases, and it can be understood that an accurate determination can be made. This principle is based on that the penalty of the learning soft margin is zero due to no error in the training data so as to increase the resolution, and accordingly, a more strict classification hyperplane can be derived. As a result of an increase in the margin, the maximum value of the generalized total evaluation value (a distance from the classification hyperplane) increases as well.

Diagram Illustrating Specific Example of Training Data Verification According to Embodiment

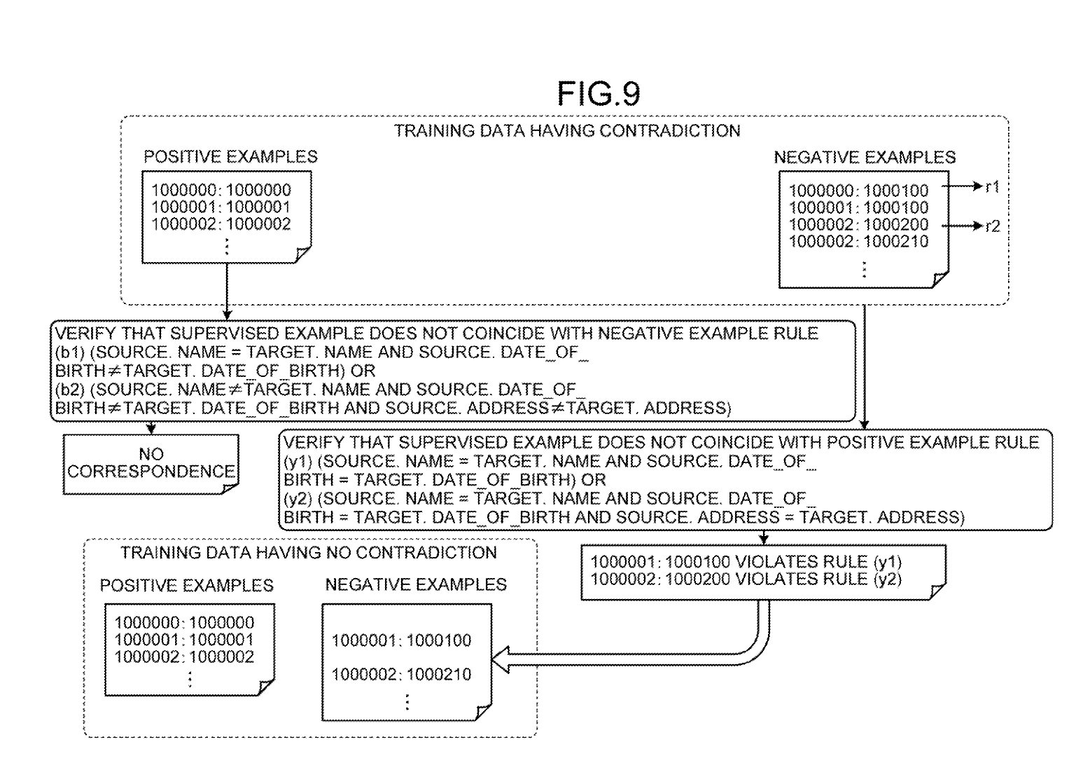

A specific example of training data verification performed by the training data verifying unit 125 by using the data of the name identification targets that is illustrated in FIG. 8A and a training data having a contradiction that is illustrated in FIG. 8B will be described with reference to FIG. 9. FIG. 9 is a diagram illustrating a specific example of a training data verifying process according to an embodiment. Here, as illustrated in FIG. 9, in a positive example rule set by the training data rule setting unit 123, the names match, and the dates of births match. In addition, in a positive example as a unspoken positive example rule, all the name identification items match. On the other hand, in a negative example rule set by the training data rule setting unit 123, even in a case where the names match, the dates of births do not match. In addition, in a negative example as a unspoken negative example rule, all the name identification items do not match. Accordingly, the positive example rule out of the training data rules is a rule that includes the positive example rule y1 set by the training data rule setting unit 123 and the unspoken positive example rule y2 as below.

“(source.name=target.name AND source.date_of_birth=target.date_of_birth) OR (source.name=target.name AND source.date_of_birth=target.date_of_birth AND source.address=target.address)”

In addition, the negative example rule out of the training data rules is a rule that includes a negative example rule b1 set by the training data rule setting unit 123 and the unspoken negative example rule b2 as below. “(source.name=target.name AND source.date_of_birth≈target.date_of_birth) OR (source.name≈target.name AND source.date_of_birth≈target.date_of_birth AND source.address≈target.address)”

A “source” used in the training data rule is an abbreviation of a name identification source, and a “target” is an abbreviation of a name identification target, and, here, both the name identification source and the name identification target represent the customer table 111A.

First, the training data verifying unit 125 verifies that a training data of the positive example out of the training datas having a contradiction does not correspond to the conditions for a negative example rule. Here, since the training data of the positive example does not correspond to the conditions for the negative example rule b1 and the negative example rule b2, the training data verifying unit 125 determines that there is no contradiction in the training data of the positive example.

Next, the training data verifying unit 125 verifies that a training data of the negative example out of the training datas having a contradiction does not correspond to the conditions for a positive example rule. Here, since the pair r1 of records of which the IDs are “1000000” and “1000100” out of the training datas of the negative example corresponds to the positive example rule y1, the training data verifying unit 125 determines that there is a contradiction therein. In other words, since the pair r1 of records coincides with the positive example rule, the pair r1 of records to be a training data of the positive example is a training data of the negative example and violates the positive example rule. In addition, since the pair r2 of records of which the IDs are “1000002” and “1000200” out of the training datas of the negative example corresponds to the positive example rule y2, the training data verifying unit 125 determines that there is a contradiction therein. In other words, the pair r2 of records violates the positive example rule. Accordingly, the training data verifying unit 125 generates appropriate training datas of the negative example by removing the pairs r1 and r2 of records in which it is determined that there is a contradiction.

Diagram Illustrating Specific Example of Generation of Training Data According to Embodiment

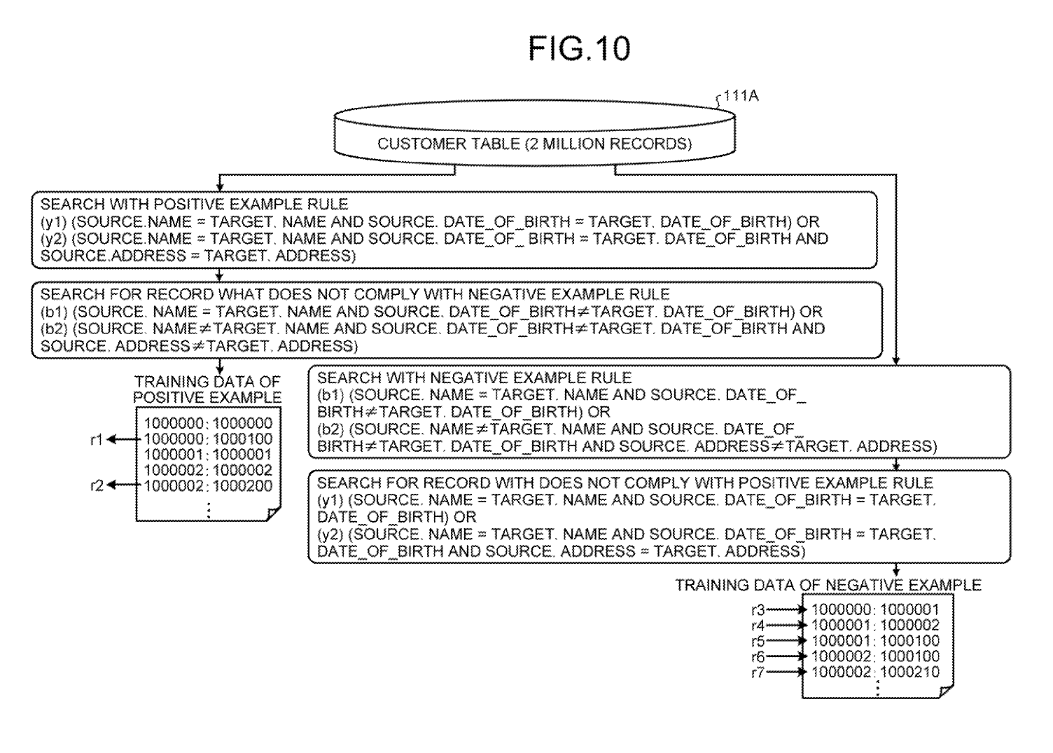

A specific example of generation of training datas using the data of the name identification targets that is illustrated in FIG. 8A by using the training data generating unit 124 will be described with reference to FIG. 10. FIG. 10 is a diagram illustrating a specific example of a training data generating process according to an embodiment. Here, in FIG. 10, the positive example rule and the negative example are the same as the rules illustrated in FIG. 9, and the description thereof will not be repeated.

First, the training data generating unit 124, for a record of a name identification source that is selected by randomly sampling records of the customer table 111A as a name identification source, searches the customer table 111A as a name identification target with the conditions for the positive example rule. Here, the training data generating unit 124 searches the customer table 111A with the conditions of a rule that includes the positive example rule y1 and the positive example rule y2. In addition, the training data generating unit 124 verifies that a pair of a retrieved record and the record of the name identification source does not correspond to a negative example rule. Here, the training data generating unit 124 verifies that the pair of records does not correspond to the conditions of the rule that includes the negative example rule b1 and the negative example rule b2. As a result of the verification, the training data generating unit 124 generates appropriate training datas of the positive example. As a result, since the names and the dates of births match and only the rear parts of the addresses are different from each other in the pair r1 of records of which IDs are “1000000” and “1000100”, and accordingly, the pair r1 of records is generated as a training data of the positive example. In addition, all the name identification items completely match in the pair r2 of the records of which the IDs are “1000002” and “1000200”, and accordingly, the pair r2 of records is generated as a training data of the positive example. The remaining sets are derived as training datas of the positive example in which the name identification items completely match those of itself (the same record).

Next, the training data generating unit 124, for a record of a name identification source that is selected by randomly sampling records of the customer table 111A as a name identification source, searches the customer table 111A as a name identification target with the conditions for the negative example rule. Here, the training data generating unit 124 searches the customer table 111A with the conditions of a rule that includes the negative example rule b1 and the negative example rule b2. In addition, the training data generating unit 124 verifies that a pair of a retrieved record and the record of the name identification source does not correspond to a positive example rule. Here, the training data generating unit 124 verifies that the pair of records does not correspond to the conditions of the rule that includes the positive example rule y1 and the positive example rule y2. As a result of the verification, the training data generating unit 124 generates appropriate training datas of the negative example. As a result, since the names, the dates of births, and the addresses do not match in the pair r3 of records of which IDs are “1000000” and “1000001”, and accordingly, the pair r3 of records does not correspond to a positive example rule and thus is generated as a training data of the negative example. In addition, the dates of births and the addresses do not match in the pair r4 of the records of which the IDs are “1000001” and “1000002”, and accordingly, the pair r4 of records does not correspond to the positive example rule and is generated as a training data of the negative example. Furthermore, the names, the dates of births, and the addresses do not match in the pair r5 of the records of which the IDs are “1000001” and “1000100”, and accordingly, the pair r5 of records does not correspond to the positive example rule and is generated as a training data of the negative example. In addition, the names, the dates of births, and the addresses do not match in the pair r7 of the records of which the IDs are “1000002” and “1000210”, and accordingly, the pair r5 of records does not correspond to a positive example rule and thus is generated as a training data of the negative example. Furthermore, although the names match, the dates of births do not match in the pair r6 of the records of which the IDs are “1000002” and “1000100”, and accordingly, the pair r6 of records does not correspond to the positive example rule and thus is generated as a training data of the negative example.

In addition, here, for simplification of the description, the requested derivation number of training datas is not covered, and an example is described in which, for the records of the target data illustrated in FIG. 8A, the records of the name identification source as processing targets are sequentially sampled from the front. However, in an actual process, when records of the name identification source are selected as processing targets, a random extracting method is performed for 2 million records, and at a time point the requested derivation number is reached, the training data generating process ends.

Next, an operation in a case where there is a contradiction between training data rules will be described with reference to FIGS. 8A to 8C and FIG. 10. When it is assumed that a rule, which is the same as the positive example rule y1 illustrated in FIG. 10, exists also in the negative example rule, there are three rules including rules y1, b1, and b2 in the negative example rule. At this time, in the process of generating a training data of the positive example illustrated in FIG. 10, a process of searching the customer table 111A with the initial positive example rule is performed, it is verified that the search result does not to correspond to the negative example rule, and a corresponding training data is removed. Accordingly, all the training datas retrieved with the positive example rule y1 correspond to the negative example rule b1 and are removed, and, as a result, it is apparent that a positive example rule corresponding to the positive example rule y1 is not detected at all. As above, any training data corresponding to a specific training data rule is not generated or the like, which is a result different from an expectation, and accordingly, by analyzing the generated training datas, a contradiction between training data rules can be detected. In addition, for a training data rule having a contradiction, an operation is performed in a direction in which a training data for the rule is not generated, and accordingly, the influence of the training data rule having a contradiction can be minimized.

### Advantages of Embodiment

According to the above-described embodiment, the information matching apparatus 1 sets training data rules that define conditions for training datas used for learning the determination criteria of the name identification through supervised learning. In other words, the information matching apparatus 1 sets training data rules that define the conditions for a training data of the positive example that is a pair of records to be determined to be identical and for a training data of the negative example that is a pair of records to be determined to be not identical. Then, the information matching apparatus 1, for a record of the name identification source, searches for records of the name identification target with the positive example rule that is a training data rule defining the conditions for training datas of the positive example, thereby generating training datas of the positive example. In addition, the information matching apparatus 1, for a record of the name identification source, searches for records of the name identification target with the negative example rule that is a training data rule defining the conditions for training datas of the negative example, thereby generating training datas of the negative example.

In such a configuration, since the information matching apparatus 1 automatically generates training datas of the positive and negative examples by using the training data rules, the training datas of the positive and negative examples can be efficiently generated without depending on a staff. As a result, the information matching apparatus 1 can start a name identification process in a simple manner. In addition, since the information matching apparatus 1 generates training datas of the positive and negative examples by using the training data rules, rules that are specialized in an operation can be used as the training data rules, whereby the training datas can be practically generated.

In addition, according to the above-described embodiment, the training data rule setting unit 123 sets the condition that all the values corresponding to the name identification items of the records match as a condition for the training data of the positive example. In addition, the training data rule setting unit 123 sets the condition that all the values corresponding to the name identification items of the records do not match as a condition for the training data of the negative example. Then, the training data rule setting unit 123 sets the training data rules that includes one of the above-described conditions in the training data generating unit 124, the training data verifying unit 125, and the name identification result judgment unit 127. In such a configuration, the training data rule setting unit 123 has the conditions for the training data of the positive example or the training data of the negative example as a default condition and includes the positive example rule or the negative example rule without defining the conditions for the training datas, and accordingly, training datas according to the included rule can be reliably generated in a speedy manner.

Furthermore, according to the above-described embodiment, the training data generating unit 124 determines whether the training data of the positive example that is generated by using the positive example rule does not coincide with the negative example rule. In addition, the training data generating unit 124 determines whether the training data of the negative example that is generated by using the negative example rule does not coincide with the positive example rule. Then, the training data generating unit 124 removes the training data of the positive example that has been determined to coincide with the negative example rule and removes the training data of the negative example that has been determined to coincide with the positive example rule. In such a configuration, since the training data generating unit 124 verifies the training data of the positive example, which is generated by using the positive example rule, by using the negative example rule other than the positive example rule, a contradiction in the generated training data of the positive example can be resolved, and a contradiction between the training data rules can be resolved. In addition, since the training data generating unit 124 verifies the training data of the negative example, which is generated by using the negative example rule, by using the positive example rule other than the negative example rule, a contradiction in the generated training data of the negative example can be resolved, and a contradiction between the training data rules can be resolved.

In addition, according to the above-described embodiment, the training data verifying unit 125 acquires a training data of the positive example or the negative example as a verification target and determines whether the acquired training data does not coincide with the rule of a classification that is opposite to the classification of the positive example of the negative example included in the training data. According to such a configuration, since the training data verifying unit 125 determines the acquired training data of the positive example by using the negative example rule other than the positive example rule, a contradiction in the acquired training data of the positive example can be verified, and a contradiction between the positive example rule and the negative example rule can be verified. Furthermore, since the training data verifying unit 125 determines the acquired training data of the negative example by using the positive example rule other than the negative example rule, a contradiction in the acquired training data of the negative example can be verified, and a contradiction between the negative example rule and the positive example rule can be verified.

In addition, according to the above-described embodiment, the training data verifying unit 125 determines whether the training data does not coincide with the rule of the classification opposite to the classification of the positive example or the negative example included in the training data and then determines whether the training data coincides with the rule of the classification that is the same as the positive example or the negative example included in the training data. In such a configuration, the training data verifying unit 125 can accurately verify the contradiction in the training datas of the positive and negative examples.

Furthermore, according to the above-described embodiment, the name identification result judgment unit 127, for the pair of records that is determined to be undeterminable as the determination result of the name identification process, determines a classification of Same (White), Different (Black) or Cannot Judge (Gray) based on the training data rules set by the training data rule setting unit 123. In such a configuration, the name identification result judgment unit 127, for the pair of records that is determined to be undeterminable as the determination result of the name identification unit 126, determines a classification of Same (White), Different (Black), or Cannot Judge (Gray) based on the training data rules, whereby the cost for a determination made by a staff can be decreased. In addition, by reflecting the determination result for the pair of records, which is determined to be undeterminable as the determination result of the name identification unit 126, based on the training data rules on the training datas by using the name identification result judgment unit 127, the accuracy of the determination result of the name identification process after the reflection can be improved.

In addition, a case has been described in which the training data rule setting unit 123, the training data generating unit 124, and the training data verifying unit 125 are consecutively operated as an example of the maintenance sequence of the training datas. However, as an example of the maintenance sequence of the training datas, the training data rule setting unit 123, the training data generating unit 124, or the training data verifying unit 125 may be individually operated. In addition, a case has been described in which the training data rule setting unit 123, the name identification result judgment unit 127, and the training data verifying unit 125 are consecutively operated as an example of the maintenance sequence of the training datas that is performed by reflecting the name identification result of no-determination on the training datas. However, as an example of the maintenance sequence of the training datas that is performed by reflecting the name identification result of no-determination on the training datas, the training data rule setting unit 123, the name identification result judgment unit 127, or the training data verifying unit 125 may be individually operated.

In addition, the name identification result judgment unit 127 has been described to acquire one pair of records of which the name identification result is undeterminable each time from the name identification unit 126 and to determine a classification of Same (White), Different (Black), or Cannot Judge (Gray). However, the name identification result judgment unit 127 may acquire a plurality of pairs of records, of which the name identification results are undeterminable, from the name identification unit 126 each time and determine classifications of Same (White), Different (Black), or Cannot Judge for the plurality of the acquired pairs of records all at once based on the training data rules. Accordingly, since the name identification result judgment unit 127 determines the pairs of records of which the name identification results are undeterminable all at once, in a case where are many pairs of records described above, a classification of Same (White), Different (Black), or Cannot Judge (Gray) can be determined in a speedy manner.

Program and the Like

In addition, the information matching apparatus 1 can be realized by mounting each function of the storage unit 11, the control unit 12, and the like in an information matching apparatus such as a general personal computer or a workstation.

Furthermore, although the information matching apparatus 1 has been described to include the training data rule setting unit 123, the training data generating unit 124, the training data verifying unit 125, and the name identification result judgment unit 127, the invention is not limited thereto. It may be configured such that an information matching apparatus that is an external device of the information matching apparatus 1 includes the training data rule setting unit 123, the training data generating unit 124, the training data verifying unit 125, and the name identification result judgment unit 127 and is connected to the information matching apparatus 1 through a network.

In addition, the constituent elements of the information matching apparatus 1 illustrated in the figures do not need to be physically configured as illustrated in the figures. In other words, a specific form of the distribution or integration of the information matching apparatus 1 is not limited to that illustrated in the figure, and the entirety or a part thereof may be configured so as to be physically divided or integrated in an arbitrary unit based on various loads, the use state, and the like. For example, the training data rule setting unit 123 and the training data generating unit 124, the training data rule setting unit 123 and the training data verifying unit 125, or the training data rule setting unit 123 and the name identification result judgment unit 127 may be integrated as one unit. On the other hand, the training data generating unit 124 may be divided into a positive example training data generating unit that generates training datas of the positive example and a negative example training data generating unit that generates training datas of the negative example. In addition, various DBs such as the name identification target DB 112 and the name identification source DB 111 may be connected to the information matching apparatus 1 through a network as external devices of the information matching apparatus 1.

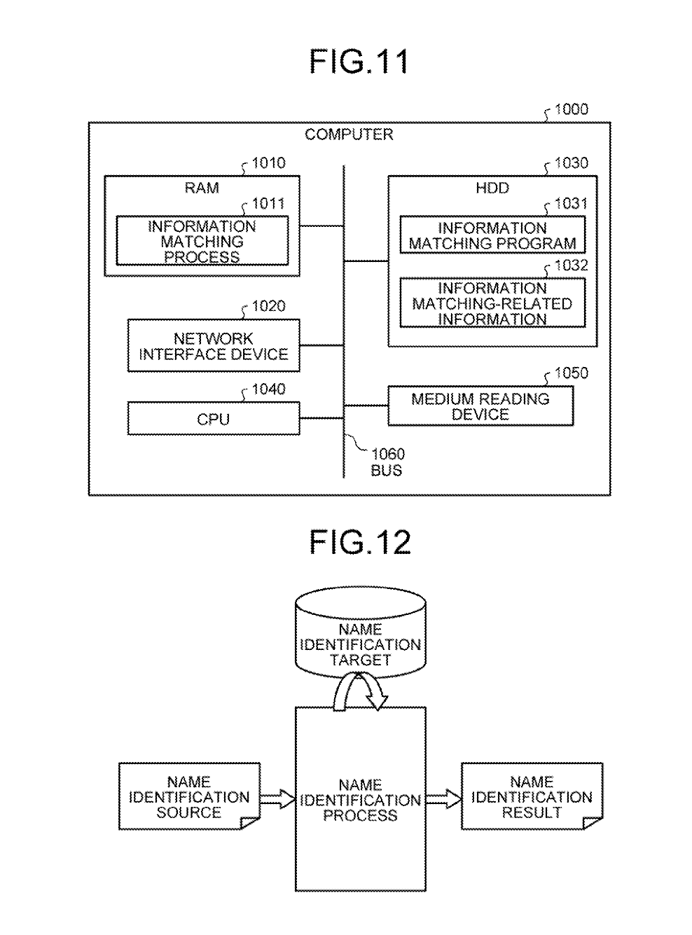

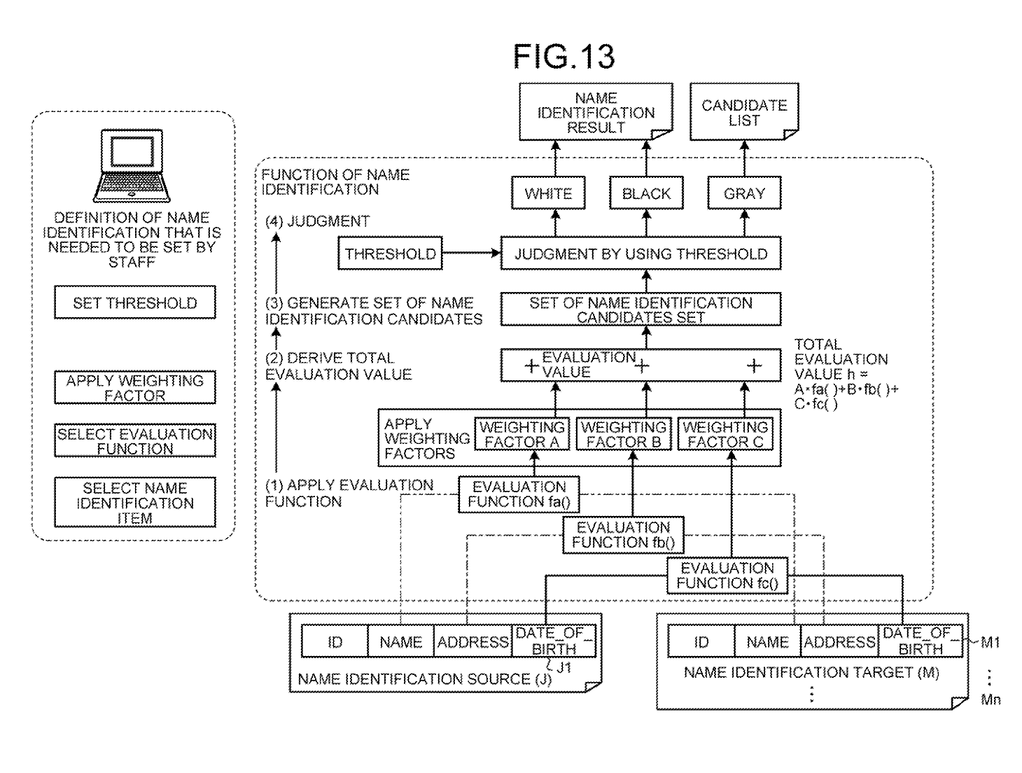

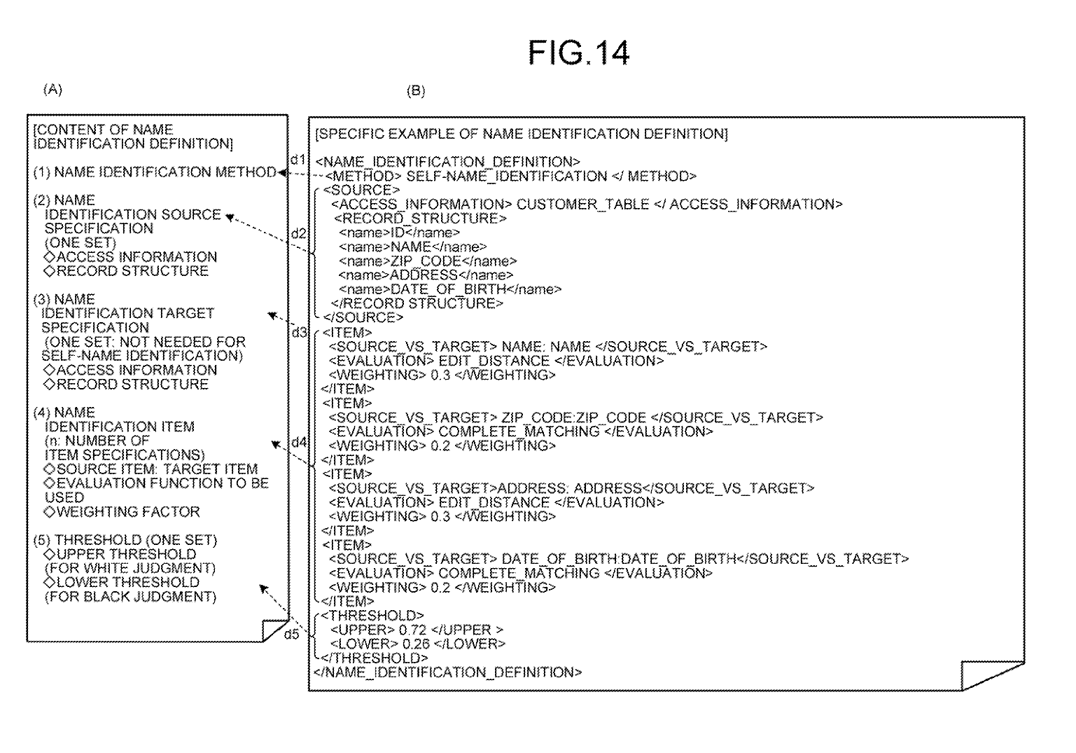

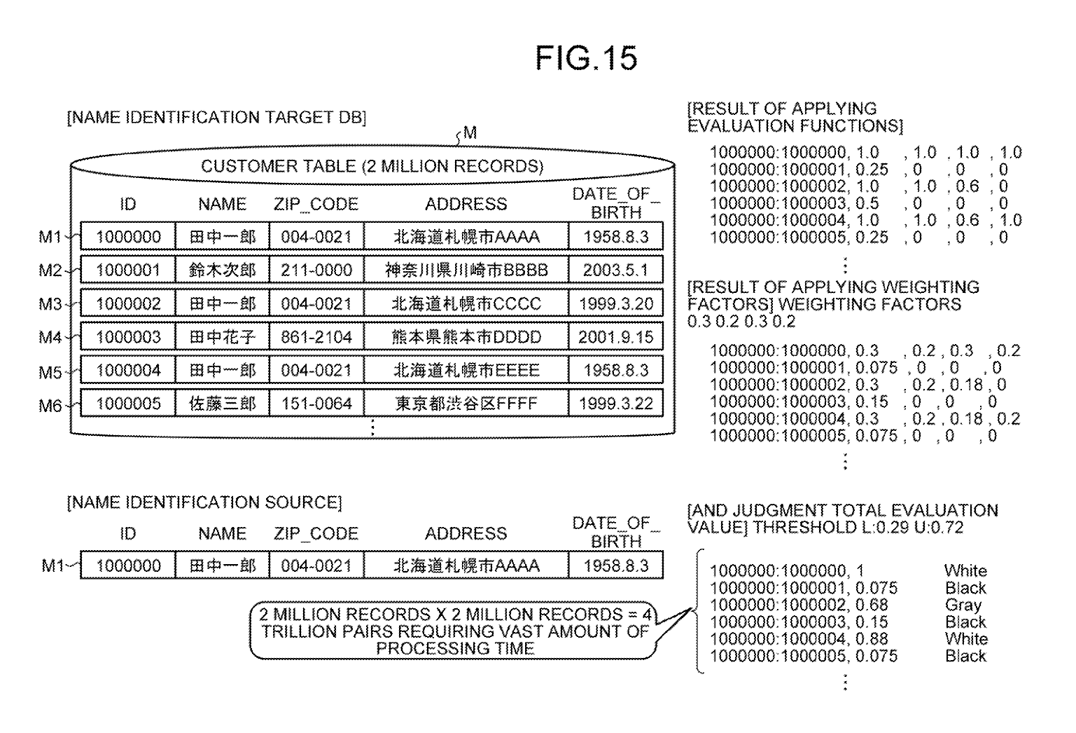

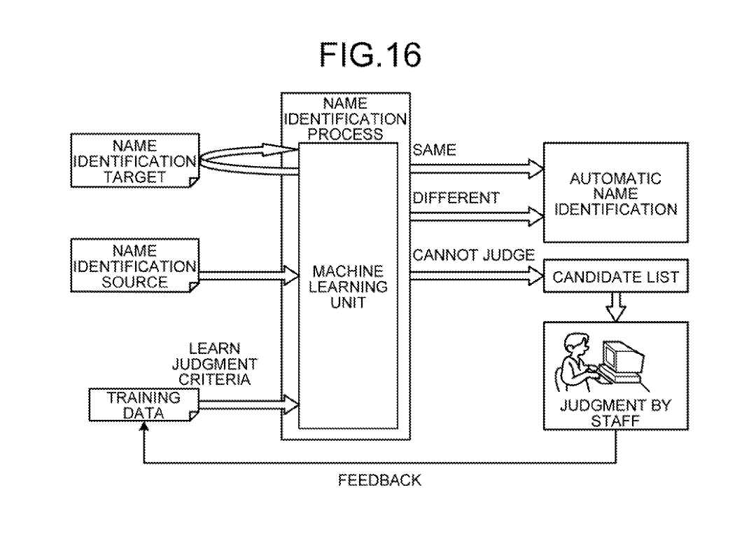

In addition, various processes described in the above-described embodiment can be realized by executing a program prepared in advance by using a computer such as a personal computer or a workstation. Thus, hereinafter, an example of a computer that executes an information matching program having the same functions as those of the control unit 12 of the information matching apparatus 1 illustrated in FIG. 1 will be described with reference to FIG. 11.

FIG. 11 is a diagram illustrating the computer that executes the information matching program. As illustrated in FIG. 11, a computer 1000 includes a RAM 1010, a network interface device 1020, an HDD 1030, a CPU 1040, a medium reading device 1050, and a bus 1060. The RAM 1010, the network interface device 1020, the HDD 1030, the CPU 1040, the medium reading device 1050 are interconnected through the bus 1060.

In the HDD 1030, an information matching program 1031 that has the same function as that of the control unit 12 illustrated in FIG. 1 is stored. In addition, in the HDD 1030, information matching-related information 1032 corresponding to the name identification target DB 112, the name identification source DB 111, the name identification definition 113, and the training data 114 illustrated in FIG. 1 is stored.

As the CPU 1040 reads out the information matching program 1031 from the HDD 1030 and expands the information matching program 1031 in the RAM 1010, the information matching program 1031 serves as an information matching process 1011. The information matching process 1011 appropriately expands the information and the like read out from the information matching-related information 1032 in an area of the RAM 1010 that is assigned by the information matching process 1011 and performs various data processing based on the expanded data and the like.

Even in a case where the information matching program 1031 or the information matching-related information 1032 is not stored in the HDD 1030, the medium reading device 1050 reads out the information matching program 1031 or the information matching-related information 1032 from a medium that stores the information matching program 1031 or the information matching-related information 1032 or the like. As examples of the medium reading device 1050, there are a CD-ROM and an optical disk device. In addition, the network interface device 1020 is a device that is connected to an external device through a network and corresponds to a wired or wireless connection.

In addition, the information matching program 1031 or the information matching-related information 1032 described above does not need to be stored in the HDD 1030, and the program or information stored on the medium reading device 1050 such as a CD-ROM may be read out and executed by the computer 1000. Furthermore, the program or the information may be stored in another computer (or a server) or the like that is connected to the computer 1000 through a public line, the Internet, a LAN, a wide area network (WAN), or the like. In such a case, the computer 1000 reads out the program or the information from the another computer through the network interface device 1020 and executes the program or the like.

In supervised learning for a name identification process, a training data can be generated efficiently and practically, and, by helping a staff to make a Gray determination, an appropriate feedback to the training data can be made.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information matching apparatus comprising:
a processor; and
a memory, wherein the processor executes:
setting rules defining conditions for supervised data of a positive example that is a pair of the records to be judged to be identical and supervised data of a negative example that is a pair of the records to be judged to be non-identical as the supervised data used for learning judgment criteria used for the judgment through supervised learning; and
generating a training data, for the record of a matching source, by generating the supervised data of the positive example by searching for the records of a matching target by using a positive example rule that is set at the setting and is a rule defining conditions for the supervised data of the positive example, and by generating the supervised data of the negative example by searching for the records of the matching target by using a negative example rule that is set at the setting and is a rule defining conditions for the supervised data of the negative example.

2. The information matching apparatus according to claim 1, wherein the setting rules that includes one of a condition that all the values corresponding to matching target items between the records match each other as a condition for the supervised data of the positive example and a condition that all the values corresponding to the matching target items between the records never match each other as a condition for the supervised data of the negative example.

3. The information matching apparatus according to claim 1, wherein the generating the training data that determines whether the generated supervised data of the positive example does not coincide with the negative example rule, determines whether the generated supervised data of the negative example does not coincide with the positive example rule, and, in a case where the supervised data coincides with the rule, removes the supervised data that coincides with the rule.

4. An information matching apparatus comprising:
a processor; and
a memory, wherein the processor executes:
setting rules defining conditions for supervised data of a positive example that is a pair of the records to be judged to be identical and supervised data of a negative example that is a pair of the records to be judged to be non-identical as the supervised data used for learning judgment criteria used for the judgment through supervised learning; and
verifying a training data by acquiring the supervised data of the positive example or the negative example and by determining whether the acquired supervised data does not coincide with the rule that is set at the setting and is a rule of a classification that is opposite to a classification of the positive example or the negative example included in the supervised data.

5. The information matching apparatus according to claim 4, wherein verifying the training data that additionally determines whether the supervised data coincides with the rule of the classification of the positive example or the negative example that is included in the supervised data.

6. An information matching apparatus comprising:
a processor; and
a memory, wherein the processor executes:
setting rules defining conditions for supervised data of a positive example that is a pair of the records to be judged to be identical and supervised data of a negative example that is a pair of the records to be judged to be non-identical as the supervised data used for learning judgment criteria used for the judgment through supervised learning; and
judging a name identification result by judging a classification of identity, non-identity, or non-judgment based on the rules set at setting for the pair of the records that is judged to be undeterminable as a result of the judgment.

7. A method of matching information performed by an information matching apparatus, the method comprising:
setting rules defining conditions for supervised data of a positive example that is a pair of the records to be judged to be identical and supervised data of a negative example that is a pair of the records to be judged to be non-identical as the supervised data used for learning judgment criteria used for the judgment through supervised learning; and
generating the supervised data of the positive example for the record of a matching source by searching for the records of a matching target by using a positive example rule that is set and is a rule defining conditions for the supervised data of the positive example, and generating the supervised data of the negative example by searching for the records of the matching target by using a negative example rule that is set and is a rule defining conditions for the supervised data of the negative example.

8. A method of matching information performed by an information matching apparatus, the method comprising:
setting rules defining conditions for supervised data of a positive example that is a pair of the records to be judged to be identical and supervised data of a negative example that is a pair of the records to be judged to be non-identical as the supervised data used for learning judgment criteria used for the judgment through supervised learning; and
acquiring the supervised data of the positive example or the negative example and determining whether the acquired supervised data does not coincide with the rule that is set and is a rule of a classification that is opposite to a classification of the positive example or the negative example included in the supervised data.

9. A method of matching information performed by an information matching apparatus, the method comprising:
setting rules defining conditions for supervised data of a positive example that is a pair of the records to be judged to be identical and supervised data of a negative example that is a pair of the records to be judged to be non-identical as the supervised data used for learning judgment criteria used for the judgment through supervised learning; and
judging a classification of identity, non-identity, or non-judgment based on the set rules for the pair of the records that is judged to be undeterminable as a result of the judgment.

10. A non-transitory computer readable storage medium having stored therein an information matching program causing an information matching apparatus, to execute a process comprising:
setting rules defining conditions for supervised data of a positive example that is a pair of the records to be judged to be identical and supervised data of a negative example that is a pair of the records to be judged to be non-identical as the supervised data used for learning judgment criteria used for the judgment through supervised learning; and
generating the supervised data of the positive example for the record of a matching source by searching for the records of a matching target by using a positive example rule that is set and is a rule defining conditions for the supervised data of the positive example, and generating the supervised data of the negative example by searching for the records of the matching target by using a negative example rule that is set and is a rule defining conditions for the supervised data of the negative example.

11. A non-transitory computer readable storage medium having stored therein an information matching program causing an information matching apparatus, to execute a process comprising:
setting rules defining conditions for supervised data of a positive example that is a pair of the records to be judged to be identical and supervised data of a negative example that is a pair of the records to be judged to be non-identical as the supervised data used for learning judgment criteria used for the judgment through supervised learning; and
acquiring the supervised data of the positive example or the negative example and determining whether the acquired supervised data does not coincide with the rule that is set and is a rule of a classification that is opposite to a classification of the positive example or the negative example included in the supervised data.

12. A non-transitory computer readable storage medium having stored therein an information matching program causing an information matching apparatus, to execute a process comprising:
setting rules defining conditions for supervised data of a positive example that is a pair of the records to be judged to be identical and supervised data of a negative example that is a pair of the records to be judged to be non-identical as the supervised data used for learning judgment criteria used for the judgment through supervised learning; and
judging a classification of identity, non-identity, or non-judgment based on the set rules for the pair of the records that is judged to be undeterminable as a result of the judgment.
